(19) United States
(12) Patent Application Publication
(10) Pub. No.: US 2022/0376529 A1
(43) Pub. Date: Nov. 24, 2022

(54) WORK AREA CHARGING

(71) Applicant: MILWAUKEE ELECTRIC TOOL CORPORATION, Brookfield, WI (US)

(72) Inventors: Kyle Reeder, Waukesha, WI (US); Christopher S. Spaulding, Green Bay, WI (US); Matthew Post, Milwaukee, WI (US); Samuel B. Petre, Brookfield, WI (US); Shreyas Sridar, Milwaukee, WI (US); Isabel M. Lloyd, West Allis, WI (US); Kevin D. White, Milwaukee, WI (US); Matthew N. Thurin, Richfield, WI (US); Gareth Mueckl, Milwaukee, WI (US); John S. Scott, Brookfield, WI (US)

(21) Appl. No.: 17/748,792

(22) Filed: May 19, 2022

Related U.S. Application Data
(60) Provisional application No. 63/213,401, filed on Jun. 22, 2021.
(60) Provisional application No. 63/190,548, filed on May 19, 2021.

(51) Int. Cl. H02J 7/00

(52) U.S. Cl. CPC H02J 7/0044; H02J 7/0013; H02J 7/0047

(57) ABSTRACT

A charging module removably receives and recharges a plurality of battery packs for use with power tools. The charging module includes a housing that has a plurality of charging bays spaced about the housing. Each of the charging bays removably receives a battery pack. A light is coupled to the housing and illuminates a space surrounding the charging module. The light illuminates a space above or below and surrounding the charging module.

### CROSS-REFERENCE TO RELATED APPLICATIONS

This application claims priority to co-pending U.S. Provisional Patent Application No. 63/190,548 filed on May 19, 2021, the entire content of which is incorporated herein by reference. This application also claims priority to co-pending U.S. Provisional Patent Application No. 63/213,401 filed on Jun. 22, 2021, the entire content of which is incorporated herein by reference.

### TECHNICAL FIELD

The present disclosure relates generally to work area charging systems, devices, and related methods.

### SUMMARY

In one embodiment, the disclosure provides a charging module configured to receive a battery pack. The charging module comprises a housing including a plurality of charging bays spaced about the housing. Each of the charging bays removably receives a battery pack. A light is coupled to the base and illuminates a space surrounding the charging module.

In another embodiment the disclosure provides a charging module configured to receive and recharge a plurality of battery packs. The charging module comprises a base that defines an internal chamber in which a plurality of charging bays are positioned. Each charging bay removably receives a battery pack. At least one door is pivotally coupled to the base. The door is pivotable between an open position and a closed position and encloses the internal chamber.

In another embodiment the disclosure provides a charging system configured to removably receive and recharge a plurality of battery packs. The charging system includes a dolly having a pair of rails, a platform rotatably coupled therebetween, and a plurality of charging modules coupled to the pair of rails. The charging modules have a housing that defines an interior compartment in which a plurality of charging bays are disposed. Each charging bay removably receives a battery pack. The charging modules are electrically coupled together.

In another embodiment, the disclosure provides a charging module including a storage box that has a main body. A lid is pivotally coupled to the main body. The lid is pivotable between an open position and a closed position. In the closed position, the lid encloses an internal chamber. A plurality of charging bays that removably receive and recharge battery packs are coupled to the storage box. A display unit is coupled to the main body. The display unit indicates a quantity of battery packs removed from the storage box.

In another embodiment, the disclosure provides a charging module including a heating unit that is configured to removably receive and recharge a plurality of battery packs. The heating unit includes a heating element and a pair of trap doors pivotally coupled to the heating unit. The pair of trap doors are pivotable between an open position and a closed position. A first charging bay is coupled to a first side of the heating unit and a second charging bay is coupled to a second side of the heating unit opposite the first charging bay. A trap door communicates each of the charging bays and the heating unit when a battery pack is coupled to the charging bay.

In yet another embodiment, the disclosure provides a charging module configured to receive and recharge a battery pack including a flexible bag. The flexible bag defines an inner storage compartment. A charging bay is coupled to the flexible bag and supported in the inner storage compartment. A cord is coupled to and extendable from the flexible storage bag. The cord is electrically coupled to the charging bay.

In another embodiment, the disclosure provides a charging module configured to removably receive and recharge a plurality of battery packs including a base, a stand, and a light. The base includes a front surface on which a plurality of charging bays, a plurality of battery holders, and a plurality of outlets are disposed. The stand is pivotally coupled to a rear surface of the base. The light is pivotally coupled to and extendable from the base. The light includes a light head pivotally coupled to a distal end of the light.

In another embodiment, the disclosure provides a charging module including a base, a locking feature, and user interface. The base includes a plurality of charging bays coupled to the base. The charging bays receive a plurality of battery packs. The locking feature is extendable from the base adjacent the charging bays and retractable into the base. The user interface including an actuator disposed in the base. An identification tag reader is supported in the base and configured to scan an identification tag. The actuator activates the identification tag reader.

Other aspects of the disclosure will become apparent by consideration of the detailed description and accompanying drawings.

### BRIEF DESCRIPTION OF THE DRAWINGS

FIG. 1 is a perspective view of an embodiment of a charging module.

FIG. 2 is a perspective view of the charging module according to FIG. 1, coupled to an existing structure.

FIG. 3 is a perspective view of the charging module according to FIG. 1.

FIG. 4 is a perspective view of the charging module according to FIG. 1.

FIG. 5 is a perspective view of the charging module according to FIG. 1.

FIG. 6 is a perspective view of the charging module according to FIG. 1.

FIG. 7 is a perspective view of another embodiment of a charging module.

FIG. 8 is an alternate perspective view of the charging module according to FIG. 7.

FIG. 9 is an enlarged perspective view of the charging module of FIG. 8.

FIG. 10 is a front view of the charging module according to FIG. 7.

FIG. 11 is a chart illustrating an operational parameter of the charging module according to FIG. 7

FIG. 12 is perspective view of another embodiment of a charging module.

FIG. 13 is a perspective view of the charging module according to FIG. 12.

FIG. 14 is a perspective view of a feature of the charging module according to FIG. 12.

FIG. 15 is a side view of the charging module according to FIG. 12, as carried by a user.

FIG. 16 is a perspective view of the charging module according to FIG. 12.

FIG. 17 is a perspective view of a feature of the charging module according to FIG. 12.

FIG. 18 is a perspective view of another embodiment of a charging module.

FIG. 19 is a side view of the charging module according to FIG. 18.

FIG. 20 is a front view of the charging module according to FIG. 18, as coupled to an existing structure.

FIG. 21 is a side view of the charging module according to FIGS. 18 and 20, as coupled to an existing structure.

FIG. 22 is a perspective view of another embodiment of a charging module.

FIG. 23 is another perspective view of the charging module according to FIG. 22.

FIG. 24 is a front view of the charging module according to FIG. 22.

FIG. 25 is an alternative front view of the charging module according to FIG. 22.

FIG. 26 is a perspective view of the charging module according to FIG. 22.

FIG. 27 is a rear perspective view of the charging module according to FIG. 22.

FIG. 28 is a side view of the charging module according to FIG. 22.

FIG. 29 is another side view of the charging module according to FIG. 22.

FIG. 30 is a perspective view of another embodiment of a charging module.

FIG. 31 is a perspective view of the charging module of FIG. 30.

FIG. 32 is a perspective view of another embodiment of a charging module.

FIG. 33 is a perspective view of the charging module according to FIG. 32.

FIG. 34 is another perspective view of the charging module according to FIG. 32.

FIG. 35 is a perspective view of another embodiment of a charging module.

FIG. 36 is a perspective view of the charging module according to FIG. 35.

FIG. 37 is a front view of the charging module according to FIG. 35.

FIG. 38 is a perspective view of the charging module according to FIG. 35, including a user interacting with the charging module.

FIG. 39 is another perspective view of the charging module according to FIG.35.

FIG. 40 is another perspective view of the charging module according to FIG. 35.

FIG. 41 is another perspective view of the charging module according to FIG. 35, placed at an exemplary worksite.

FIG. 42 is another perspective view of the charging module according to FIG. 35, placed at an exemplary worksite.

FIG. 43 is a perspective view of another embodiment of a charging module.

FIG. 44 is another perspective view of the charging module according to FIG. 43.

FIG. 45 is a front view of the charging module according to FIG. 43.

FIG. 46 is a rear view of the charging module according to FIG. 43.

FIG. 47 is a perspective view of another embodiment of a charging module.

FIG. 48 is a front view of the charging module according to FIG. 47 illustrating operation of the charging module.

FIG. 49 is another front view of the charging module according to FIG. 47 illustrating operation of the charging module.

FIG. 50 is a top section view of a hook of the charging module according to FIG. 47.

FIG. 51 is a side view of the charging module according to FIG. 47 as coupled to a surface.

FIG. 52 is a side view of another embodiment of a charging module.

FIG. 53 is a perspective view of the charging module according to FIG. 52.

FIG. 54 is a perspective view of another embodiment of a charging module.

FIG. 55 is a diagram of a charging module according to FIG. 54.

FIG. 56 is a diagram of an alternative embodiment of a charging module according to FIG. 54.

FIG. 57 is a perspective view of another embodiment of a charging module according to FIG. 54.

FIG. 58 is another perspective view of the charging module according to FIG. 57.

FIG. 59 is a perspective view of another embodiment of a charging module.

FIG. 60 is a front view of the charging module according to FIG. 59.

FIG. 61 is another front view of the charging module according to FIG. 59.

FIG. 62 is another front view of the charging module according to FIG. 59.

FIG. 63 is a perspective view of the charging module according to FIG. 59.

FIG. 64 is a perspective view of another embodiment of a charging module.

FIG. 65 is a front section view of the charging module according to FIG. 64.

FIG. 66 is a rear perspective view of the charging module according to FIG. 64.

FIG. 67 is a perspective view of a charging system including charging modules according to FIG. 64.

FIG. 68 is a rear perspective view of the charging system according to FIG. 67.

FIG. 69 is a perspective view of another embodiment of a charging module.

FIG. 70 is another perspective view of the charging module according to FIG. 69, illustrating operation of the charging module.

FIG. 71 is another perspective view of the charging module according to FIG. 69, illustrating operation of the charging module.

FIG. 72 is another perspective view of the charging module according to FIG. 69, illustrating operation of the charging module.

FIG. 73 is a schematic illustrating operation of the charging module according to FIG. 69.

FIG. 74 is a perspective view of a key fob operable with the charging module of FIG. 69.

FIG. 75 is a perspective view of a bracelet operable with the charging module according to FIG. 69.

FIG. 76 is a perspective view of a key card operable with the charging module according to FIG. 69.

FIG. 77 is a perspective view of an adhesive tag operable with the charging module of FIG. 69.

FIG. 78 is a perspective view of another embodiment of a charging module.

FIG. 79 is a perspective view of another embodiment of a charging module.

FIG. 80 is a perspective view of the charging module according to FIG. 79.

FIG. 81 is a perspective view of a battery pack with an identification tag operable with the charging module according to FIG. 79.

FIG. 82 is an enlarged perspective view of the charging module according to FIG. 79.

FIG. 83 is a perspective view of another embodiment of a charging module.

FIG. 84 is a perspective view of another embodiment of a charging module.

FIG. 85 is a perspective view of the charging module according to FIG. 84.

FIG. 86 is a perspective view of the charging module according to FIG. 84 as carried by a user.

FIG. 87 is a perspective view of the charging module according to FIG. 84 as coupled to an existing structure.

FIG. 88 is a perspective view of another embodiment of a charging module.

FIG. 89 is another perspective view of the charging module according to FIG. 88.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

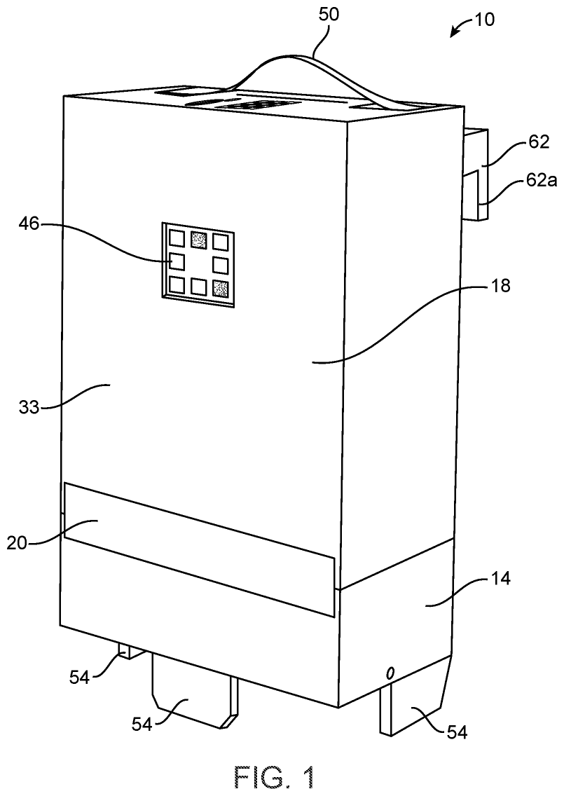

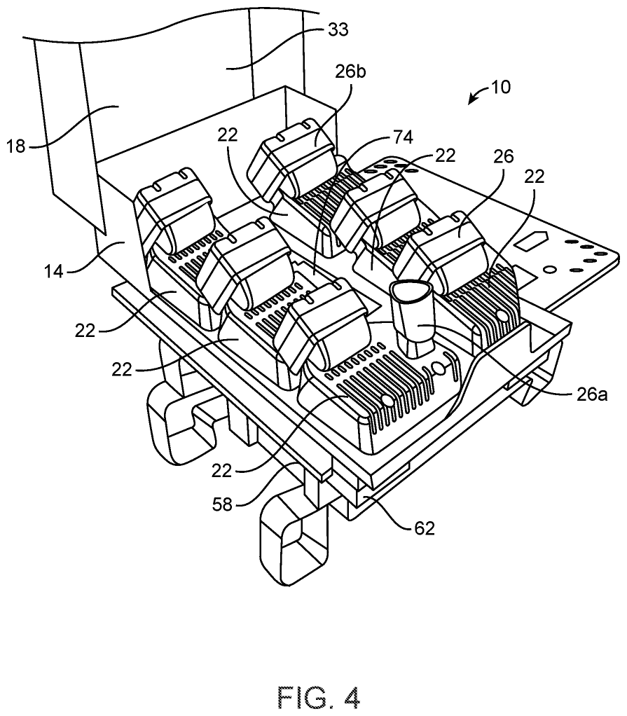

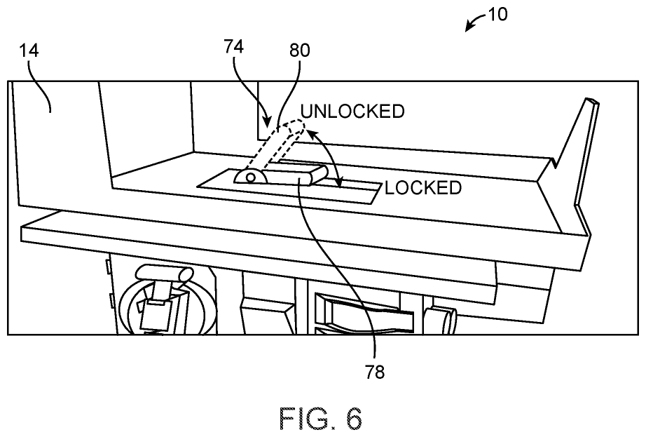

FIGS. 1-6 illustrate a first embodiment of a charging module 10 for a work area. The charging module 10 is generally rectangular and includes a base 14 and a lid 18 pivotably coupled to the base 14 at a hinge 20. The base 14 includes various charging bays 22 shaped and sized to receive battery packs 26. In the illustrated embodiment, the base 14 includes two charging bays 22 to receive 12-volt power tool battery packs 26a and six bays to receive 18-volt power tool battery packs 26b. However, in alternative embodiments, the base 14 may include fewer or additional charging bays 22 to support different quantities of power tool battery packs 26 having the same or different voltage capacities.

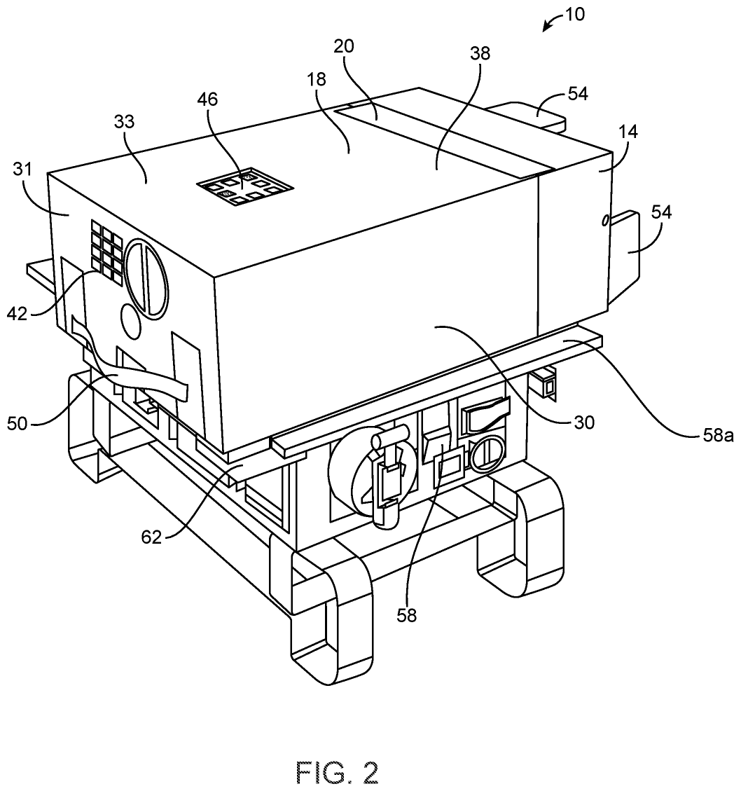

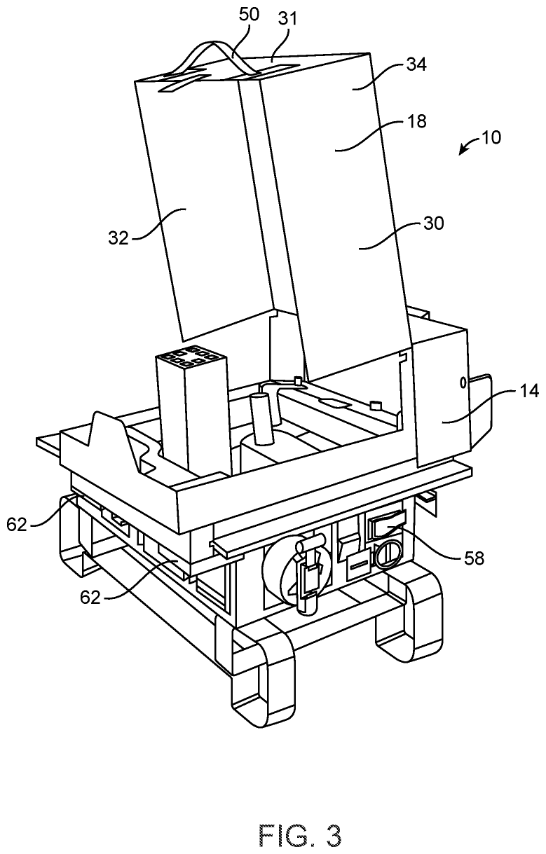

The lid 18 includes three sidewalls 30, 31, 32 and a top surface 33 that is generally flat. The hinge 20 is coupled to the top surface 33. The lid 18 is pivotable about the hinge 20 relative to the base 14 between a first, open position 34 (FIG. 3) and a second, closed position 38 (FIG. 1). When the lid 18 is in the closed position 38, the lid 18 encloses the charging bays 22 and battery packs 26 and prevents the battery packs 26 from being exposed to a harsh environment. With continued reference to FIG. 2, the lid 18 additionally includes a control panel 42 positioned on a side wall 31. The control panel 42 may be positioned on the other side walls 30, 32 or top surface 33 instead. The control panel 42 is configured to secure the lid 18 in the closed position 38 and prevent removal of battery packs 26 by unauthorized users. In that regard, for a user to move the lid 18 to the open position 34 and access the battery packs 26, a user must take an action, such as entering a key (not shown) and/or a password, to unlock the lid 18. The lid 18 also supports charge indicators 46 that are configured to provide visual indication of the status (i.e., battery health, charge amount, temperature, etc.) of battery packs 26 coupled to the charging bays 22. The charge indicators 46 may be supported in the top surface 33, or may instead be integrated with the control panel 42, or supported by the side walls 30, 31, 32 of the lid 18 in another position. A handle 50 extends from a side wall 31 of the lid 18 and provides a grip for the user to grasp to carry the charging module 10 about a worksite.

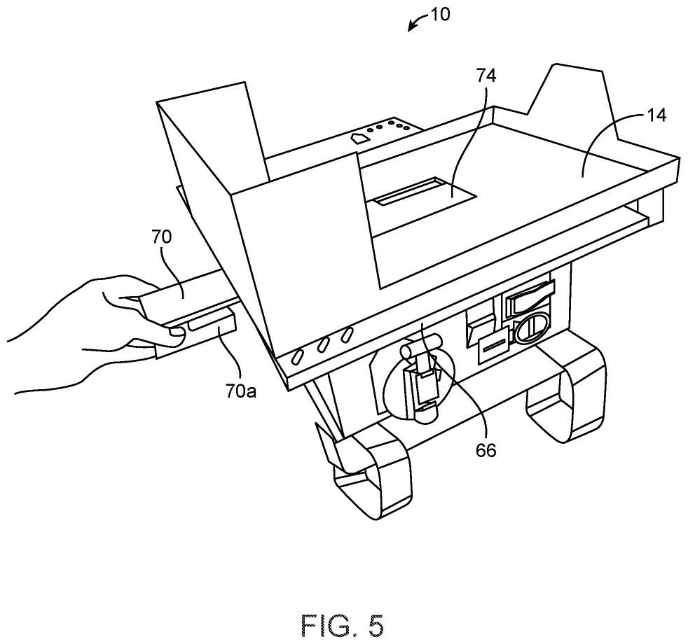

With continued reference to FIG. 1, a plurality of feet 54 extend from the base 14 in a direction away from the lid 18 and support the charging module 10 in a free-standing position (FIG. 1). As illustrated in the present embodiment, the charging module 10 includes three feet, however, other quantities of feet may be used. With reference to FIG. 3, the charging module 10 may instead be removably coupled to an existing structure 58 (e.g., a spider box, a stud frame, etc.). More specifically, the charging module 10 is supported on a flat surface 58a of the structure 58. In that regard, a plurality of mounting arms 62 including a hook portion 62a extend from an underside 66 of the base 14, opposite the lid 18. The hook portion 62a engages the existing structure 58. As illustrated in the present embodiment, the charging module 10 has two mounting arms, but another quantity may be used. With reference to FIG. 5, an adjustable clamp 70 protrudes from the base 14 of the charging module 10 opposite the mounting arms 62, to secure the charging module 10 to the structure 58. The adjustable clamp 70 includes a clamping portion 70a that engages the existing structure 58. The adjustable clamp 70 is extendable from the base 14 to accommodate existing structures having various sizes. The base 14 additionally includes a locking cam lever 74 mechanically coupled to the adjustable clamp 70. The locking cam lever 74 is pivotable between a first, locked position 78 and a second, unlocked position 80. When the locking cam lever 74 is in the locked position 78, the adjustable clamp 70 is secured in a position relative to the base 14. The locking cam lever 74 is disposed in the base 14 so as to be enclosed when the lid 18 is in the closed position 38, thereby ensuring the adjustable clamp 70 cannot be inadvertently released. The locking cam lever 74 may additionally, or alternatively, be configured to lock the lid 18 in the open position 34 or closed position 38.

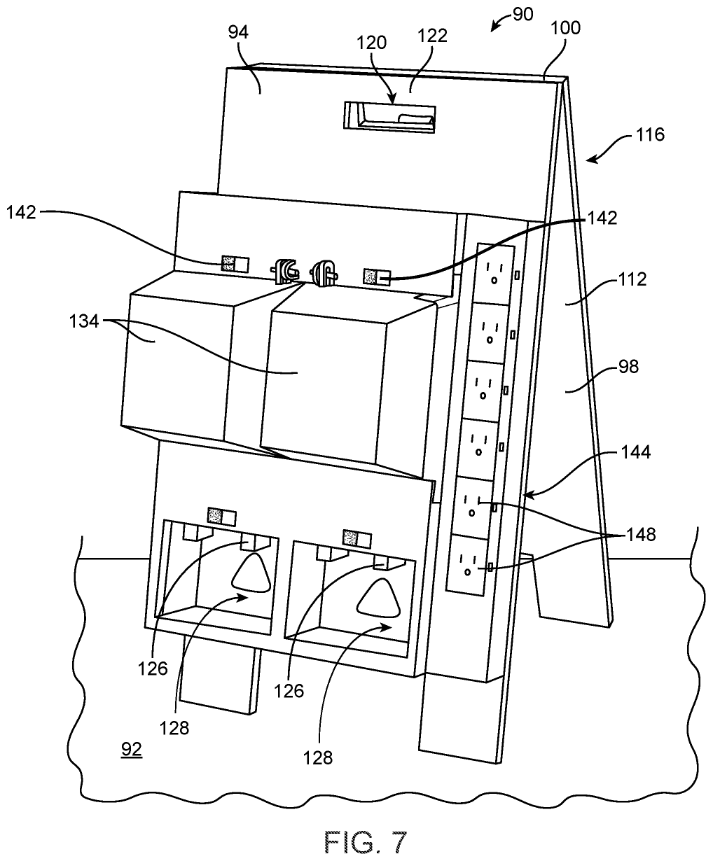

FIGS. 7-11 illustrate another embodiment of a charging module 90 for a work area. The charging module 90 is positionable on a top surface of a mobile work cart (not shown) or placed directly on a work surface 92 (e.g., ground). The charging module 90 includes a first panel 94 and a second panel 98 pivotable relative to the first panel 94 about a hinge 100. The first and second panels 94, 98 are movable from a first, stowed position 104, where an inner surface 108 of the first panel 94 engages an inner surface 112 of the second panel 98 (e.g., such that the first panel 94 and second panel 98 are generally parallel to each other), to a second position 116, where the first panel 94 is pivoted away from the second panel 98 about the hinge 100 (e.g., such that the first panel 94 and second panel 98 are angled relative to each other). When the charging module 90 is in the second position 116, the first panel 94 and/or the second panel 98 may serve as a work surface (e.g., drafting table, easel, etc.) for the user.

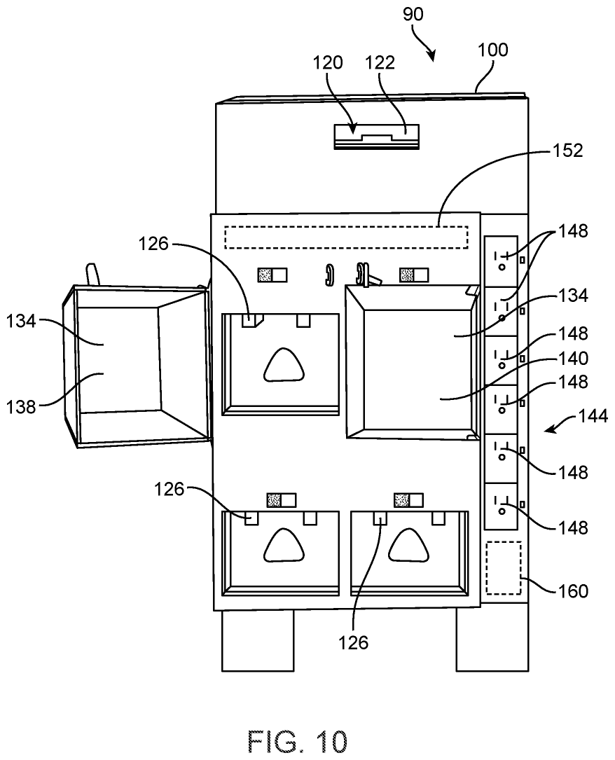

With reference to FIG. 10, an aperture 120 extends through the first and second panels 94, 98 to form a handle 122 for the user, such that the user may transport the charging module 90 when it is in the stowed position 104. The first panel 94 additionally includes a plurality of charging bays 126 for receiving a battery pack 130 (e.g., a power tool battery pack). The charging bays 126 are disposed in cavities 128 that extend into the first panel 94. The first panel 94 may instead include a flush surface (not shown) to which the charging bays 126 are coupled. The first panel 94 further includes security covers 134 pivotally coupled to the first panel 94 and configured to cover the charging bays 126. In the illustrated embodiment, the first panel 94 includes four charging bays 126 disposed in four cavities 128 that extend into the first panel 94, and the charging bays 126 are configured to receive power tool battery packs 130. As further illustrated in the present embodiment, the first panel 94 includes four security covers 134, each security cover 134 pivotably coupled to the first panel 94. The security covers 134 are pivotable between an open position 138 and a closed position 140. When the security covers 134 are in the closed position 140, the security covers 134 enclose the battery packs 130 coupled to the charging bays 126, and in some embodiments, the security covers 134 are lockable in the closed position 140. A plurality of indicators 142 may be positioned in the first panel 94 adjacent each of the charging bays 126. The indicators 142 are configured to indicate a status (e.g., charge completion, battery health, etc.) of the battery pack 130 coupled to the charging bay 126.

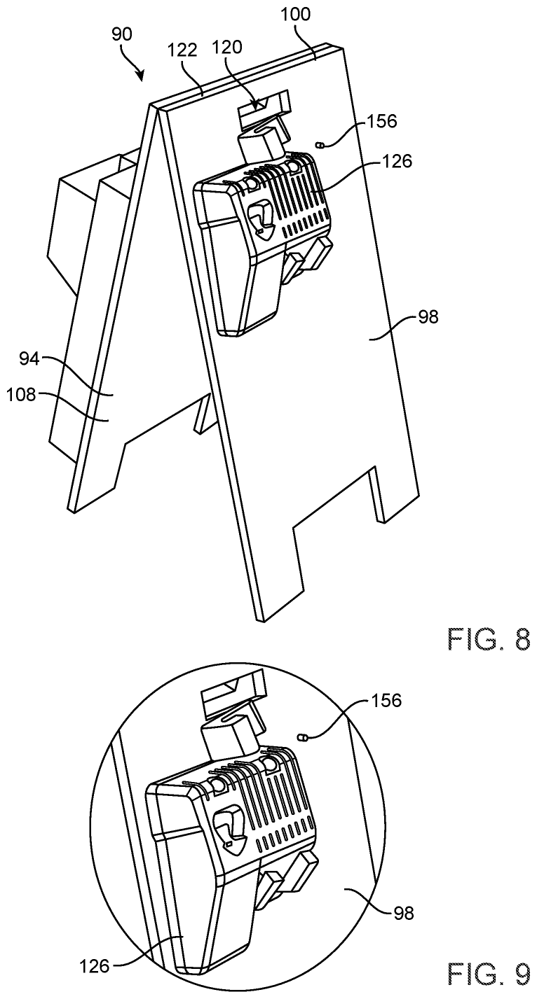

With reference to FIG. 10, a power strip 144 is coupled to the first panel 94. The power strip 144 includes a plurality of outlets 148, such as pass-through outlets 148 that are configured to allow power from a power source (e.g., battery packs 130 coupled to the charging bays 126, AC mains power electrically coupled to the charging module 90, etc.) to pass through the charging module 90 to an accessory (not pictured) that is electrically coupled to the power strip 144. In the illustrated embodiment, the charging module 90 has six outlets 148, but other quantities may be included instead. In another embodiment of the charging module 90, a battery core 152 is supported in the first panel 94. The battery core 152 may instead be supported in the second panel 98. The battery core 152 is rechargeable and may be electrically coupled to the charging bays 126, the power strip 144 and pass-through outlets 148, or other components, as a power source. With reference to FIGS. 8-9, the second panel 98 includes a plurality of pegs 156 (e.g., two pegs) for mounting various battery packs 130, charging bays 126, tools, etc.

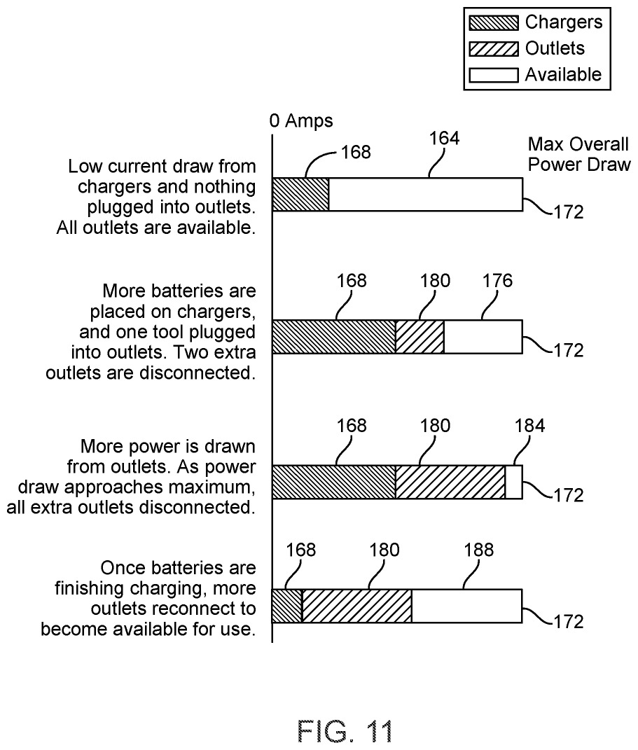

In another embodiment of the charging module 90, the power strip 144 includes a smart load controller 160 that monitors the total combined power draw of the battery pack(s) 130 and the outlets 148 of the power strip 144, and disables the outlets 148 and/or limits the charging power of the charging bays 126 to prevent overdrawing the circuit and tripping a circuit breaker (not shown). With reference to FIG. 11, a first bar 164 indicates a lower current draw representative of minimal use of charging bays 126 and pass-through outlets 148 in comparison to the charging module's maximum overall power draw available 172, resulting from, for instance, the charging bay current draw 168 of one battery pack 130 coupled to a charging bay 126 and no usage of pass-through outlets 148. A second bar 176 represents a generally higher current draw, representative of increased charging bay current draw 168 and pass-through outlet current draw 180 in comparison to the charging module's maximum overall power draw available 172, resulting from, for instance, a higher quantity of battery packs 130 coupled to the charging bays 126 and an additional tool plugged into a pass-through outlet 148. As the combined charging bay current draw 168 and pass-through outlet current draw 180 approach the charging module's maximum overall power draw available 180, the smart load controller 160 disables a current draw for pass-through outlets 148 not in use. A third bar 184 represents a higher current draw than the second bar 176, which is indicative of, for instance, battery packs 130 coupled to all of the charging bays 126 and receiving a charge from the charging bays 126 and pass-through outlets 148 drawing increased power. As the combined charging bay current draw 168 and pass-through outlet current draw 180 approach the charging module's maximum overall power draw available 180, the smart load controller 160 disables extra pass-through outlets 148. A fourth bar 188 represents a reduction in combined charging bay current draw 168 and pass-through outlet current draw 180, for instance, when the smart load controller 160 disables a charging bay 126 after the battery pack 130 coupled thereto has completed charging, at which point the smart load controller 160 reconnects disabled pass-through outlets 148.

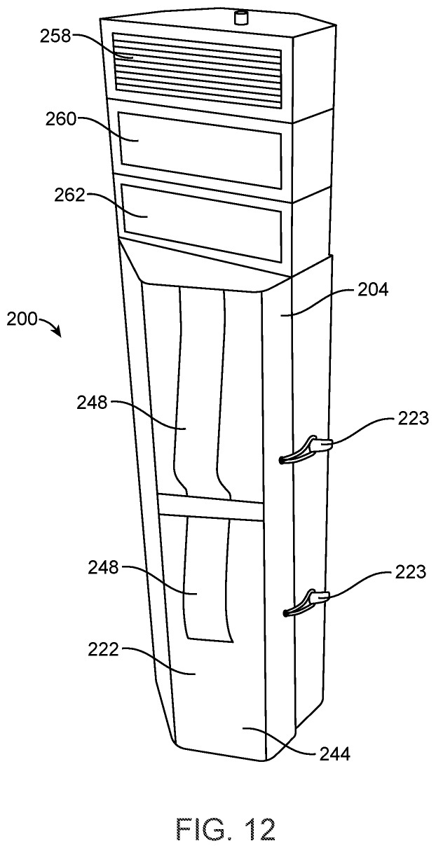

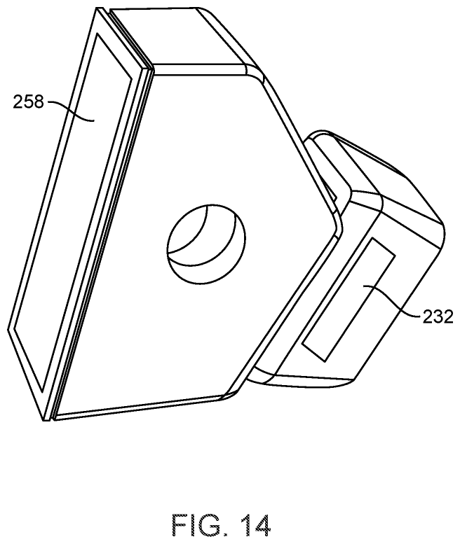

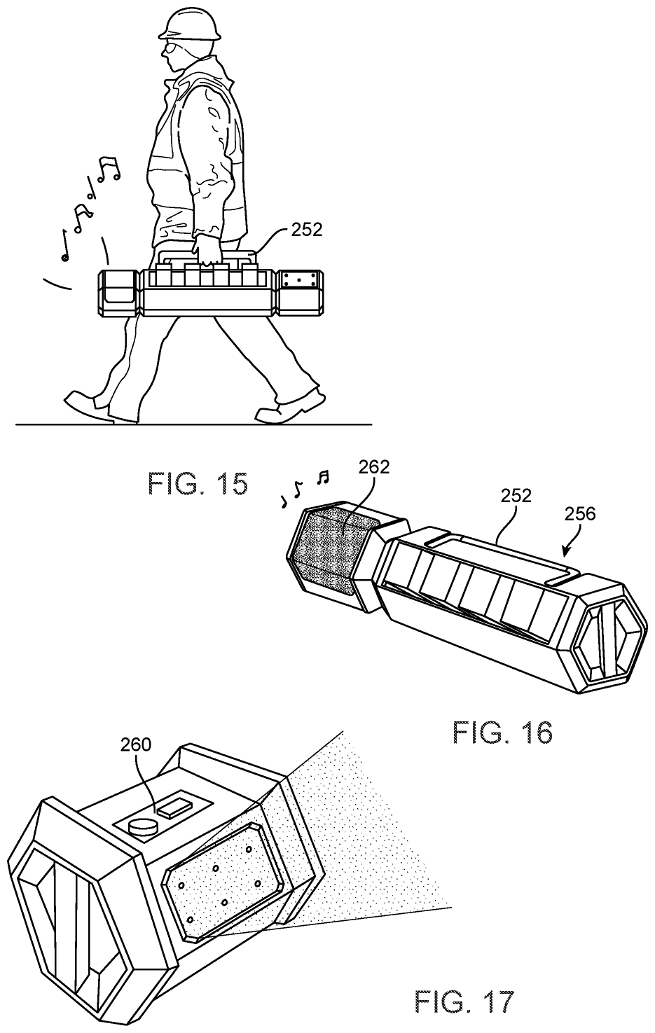

FIGS. 12-17 illustrate another embodiment of a charging module 200 for a work area. The charging module 200 has a case 204 that is generally hexagonal-shaped and includes a base 208 and a door 212 pivotable relative to the base 208 about a hinge 216. The door 212 is pivotable relative to the base 208 between a first, open position 220, and a second, closed position 222. When the door 212 is in the closed position 222, the door 212 may be selectively coupled to the base 208 by a latch 223. In the illustrated embodiment, the charging module 200 may include two latches, but other quantities of latches may be used instead. The door 212 may be locked relative to the base 208 using a lock (not shown) disposed in the base 208 or door 212, or externally engaging the base 208 or door 212.

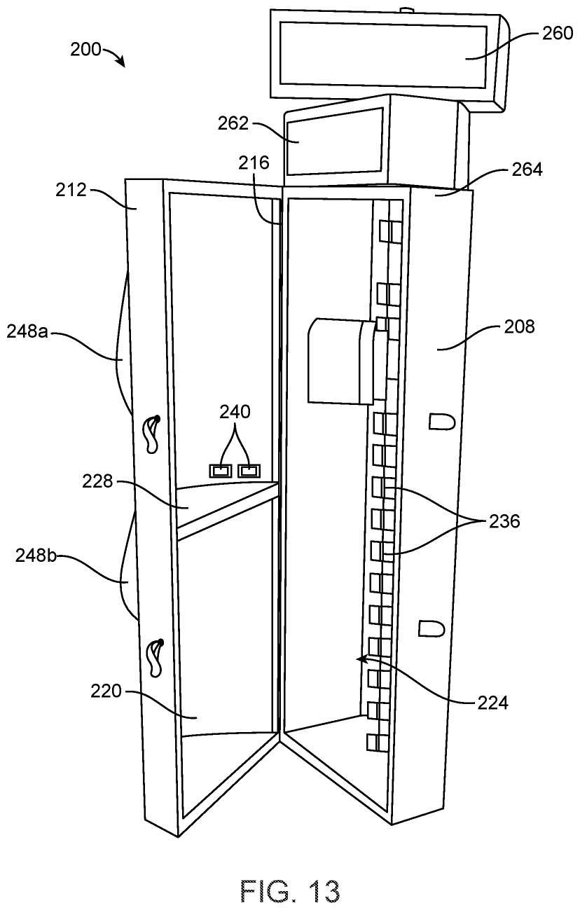

With reference to FIG. 13, the base 208 defines an internal compartment 224 including shelves 228 for storing various accessories (e.g., battery packs 232, etc.). The internal compartment 224 includes various charging bays 236 for receiving a battery pack 232 (e.g., a power tool battery pack). In the illustrated embodiment, the charging bays 236 are configured to receive 12-volt and/or 18-volt power tool battery packs. The internal compartment 224 additionally includes ports 240 (e.g., USB ports) configured to charge additional accessories (e.g., tablet, mobile phone, etc.). An outer surface 244 of the door 212 includes a dual handle 248 including two gripping portions 248a, 248b, which allows the user to easily transport the charging module 200. The charging module 200 may instead include a single elongated handle 252 disposed in a handle recess 256 defined in the base 208 or the door 212 of the case 204. The elongated handle 252 is pivotally coupled to the charging module 200 for pivoting out of the handle recess 256 for a user to grasp to transport the charging module 200.

With continued reference to FIGS. 14-17, various detachable, quick-release accessories (e.g., a fan 258, an LED light 260, a speaker 262, etc.) are coupled to the case 204 at a first end 264 of the case 204. The accessories may be AC-powered when coupled to the case 204 and battery-powered when uncoupled from the case 204. When coupled to the case 204, the accessories are configured to swivel relative to the case 204 and independently of the other accessories coupled to the case 204, thereby allowing the user to orient the accessories in a particular direction.

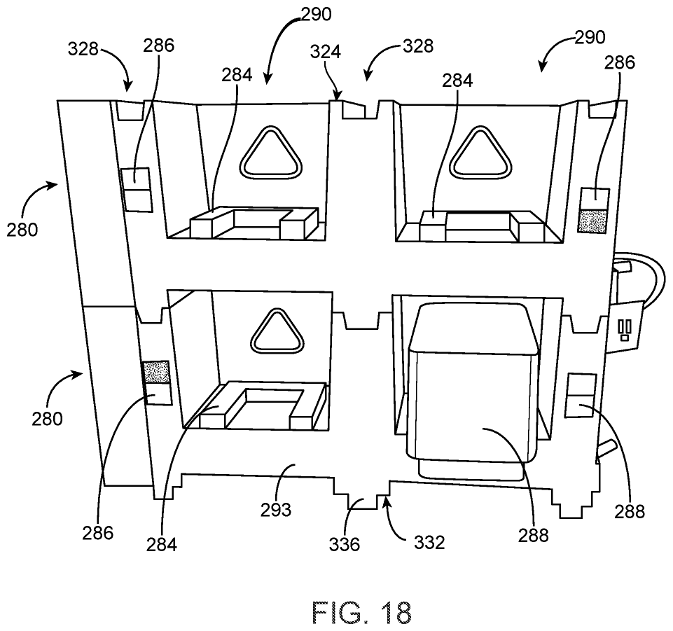

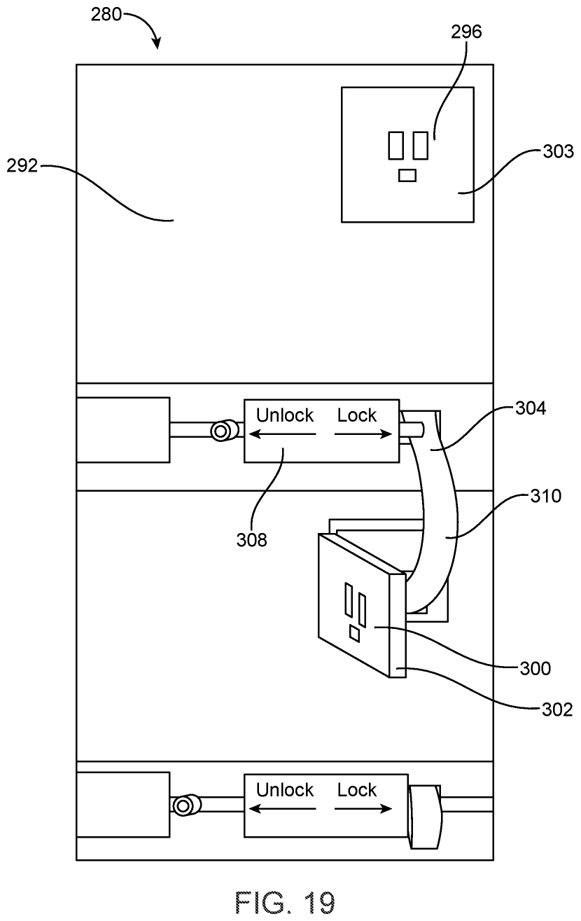

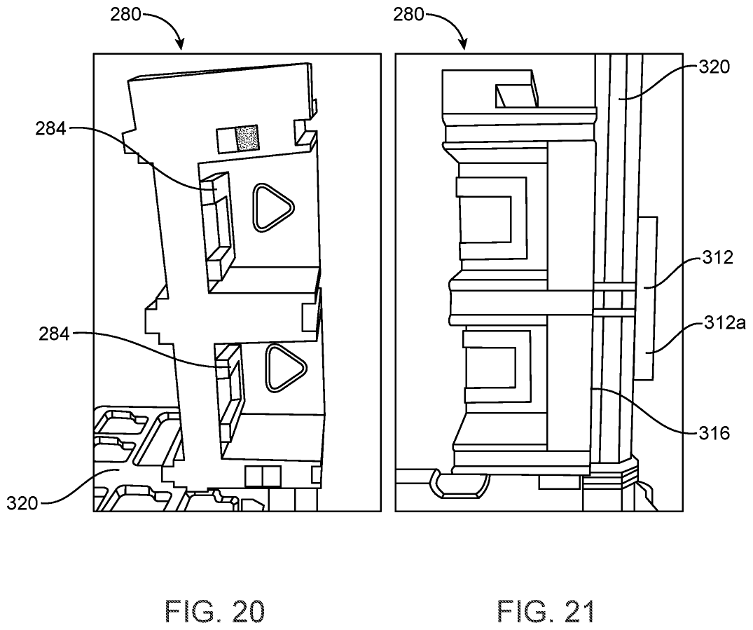

FIGS. 18-21 illustrate another embodiment of a charging module 280 for a work area. The charging module 280 is generally rectangular and includes various charging bays 284 for receiving a battery pack 288 (e.g., a 12-volt or 18-volt power tool battery pack). Each of the charging bays 284 are disposed in a recess 290 that extends inward toward a center of the charging module 280. In the illustrated embodiment, the charging module 280 includes two charging bays 284 configured to receive two power tool battery packs 288, however other quantities of charging bays 284 may be used. A plurality of indicators 286 may be disposed adjacent the recesses 290 on a front surface 293 of the charging module 280, which indicate a status (e.g., charging status, battery health, etc.) of the battery pack 288 coupled to the charging bay 284.

A port 296 is disposed on a side surface 292 of the charging module 280. The port 296 is illustrated as an AC pass-through port, but other ports (e.g., a USB port) may be used. A cover 300 is pivotally coupled to the side surface 292 and is pivotable between an open position 302 and a closed position 303. A cord 304 is disposed in the charging module 280. The cord 304 can be extended from the side surface 292 of the charging module 280 and retracted into the charge module 280 for storage when not in use. The charging module 280 includes a lock 308 for locking the cord 304 in an extended position 310.

With reference to FIG. 21, an extension clamp 312 extends from a back surface 316 of the charging module 280 enabling the charging module 280 to be removably coupled to an existing structure 320 (e.g., a spider box, a post, etc.) for off-ground charging. The extension clamp 312 includes a clamping portion 312a that engages the existing structure 320 and sandwiches the existing structure 320 between the extension clamp 312 and the back surface 316.

Returning with reference to FIG. 18, the charging module 280 is shaped and sized to be stacked onto additional charging modules 280. Specifically, an upper face 324 of the charging module 280 includes a plurality of grooves 328 extending into the upper face 324 of the charging module 280. The charging module 280 also includes a lower face 332 and a flange 336 that extends from the lower face 332. When the charging modules 280 are stacked onto each other, the flange 336 of the first charging module 280 is received within the groove 328 of the second charging module 280. In such instances, the stacked charging modules 280 may be electrically coupled, i.e., “daisy-chained” together, via the port 296 and cord 304. The flange 336 on the lower face 332 of the charging module 280 additionally acts as a leg for the charging module 280, thereby supporting the charging module 280.

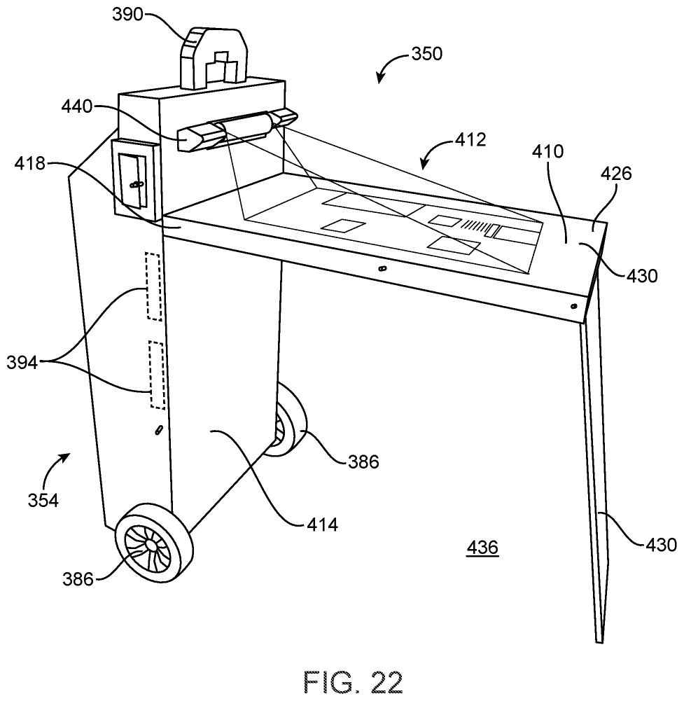

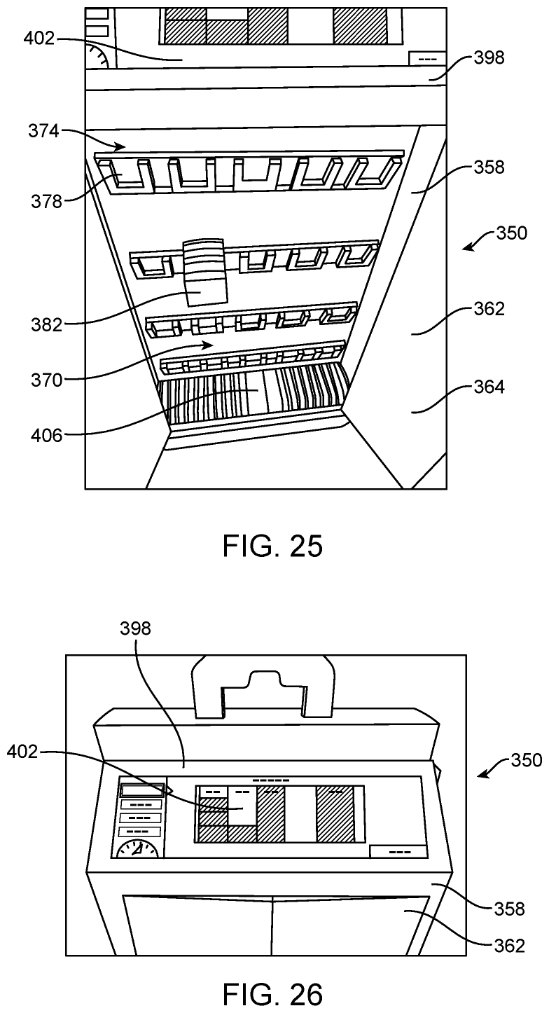

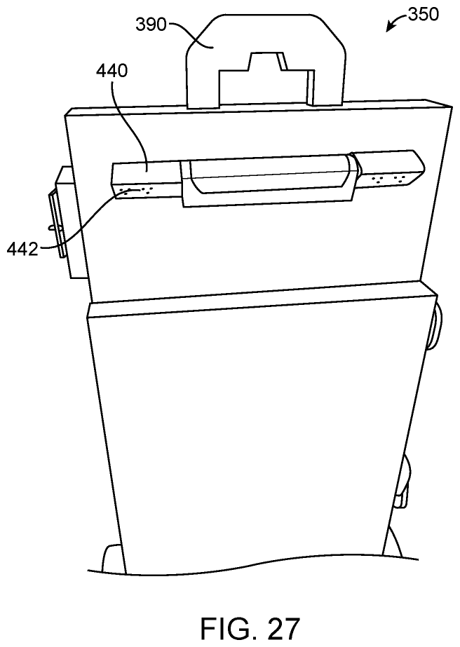

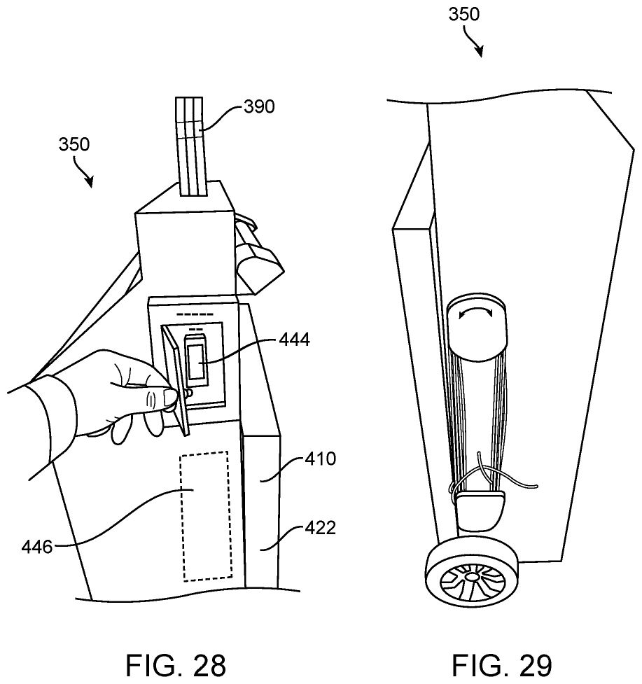

FIGS. 22-29 illustrate another embodiment of a charging module 350 for a work area. The charging module 350 includes a cabinet 354 that is generally rectangular. The cabinet 354 includes a base 358, and two doors 362 that are pivotable relative to the base 358 between an open position 364 and a closed position 366. A lock (not shown) may be coupled to the base 358 or the doors 362 and engage and lock the doors 362 thereby preventing access to the cabinet 354. An interior 370 of the base 358 defines a storage compartment 374 for holding various power sources. Specifically, the interior 370 of the base 358 includes charging bays 378 for receiving battery packs 382 (e.g., a power tool battery pack). In the illustrated embodiment, the interior 370 of the base 358 includes twenty charging bays 378 configured to receive power tool battery packs 382, arranged in four rows of five charging bays 378. The charging bays 378 may be arranged in other layouts including fewer or more rows and other quantities of charging bays 378 per row. A pair of wheels 386 are coupled to the cabinet 354 for rolling the charging module 350 to different locations at a worksite. A lifting hook 390 extends from the cabinet 354 opposite the pair of wheels 386. The lifting hook 390 is engageable by an overhead crane or other overhead lifting fixture (not shown) for transporting the charging module 350 about a worksite. The cabinet 354 may also include pockets 394 for engagement by the forks of a lift truck (not shown).

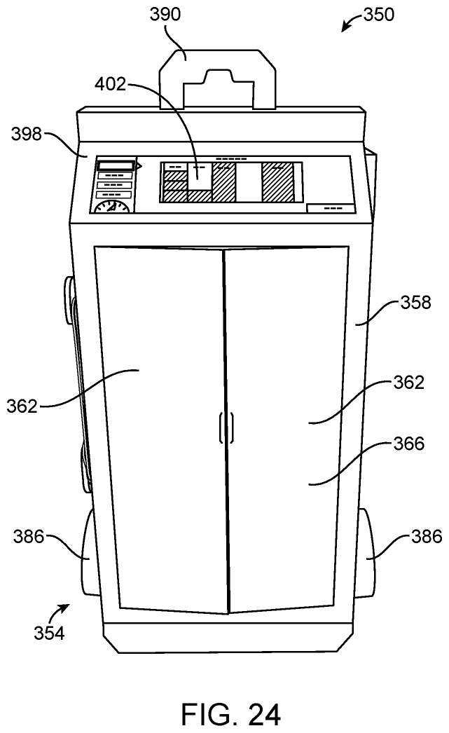

With continued reference to FIG. 24, an upper surface 398 of the base 358 includes a user interface 402. The user interface 402 includes a display 404 (e.g., a touchscreen display) which provides information on the battery packs 382 coupled to the charging bays 378. The display 404 may display information such as charging status, ownership, battery health, overall power draw on the system, etc. The user interface 402 may additionally be configured to unlock the doors 362, for instance, by entering a password, a key, etc.

The cabinet 354 additionally includes an integrated HVAC system 406. The HVAC system 406 moves air throughout the cabinet 354 (e.g., around the battery packs 382 in the charging bays 378) in order to maintain optimal battery charging in harsh environments. Specifically, the HVAC system 406 may include a heating element (not shown) and a fan (not shown) to move heated air throughout the cabinet 354.

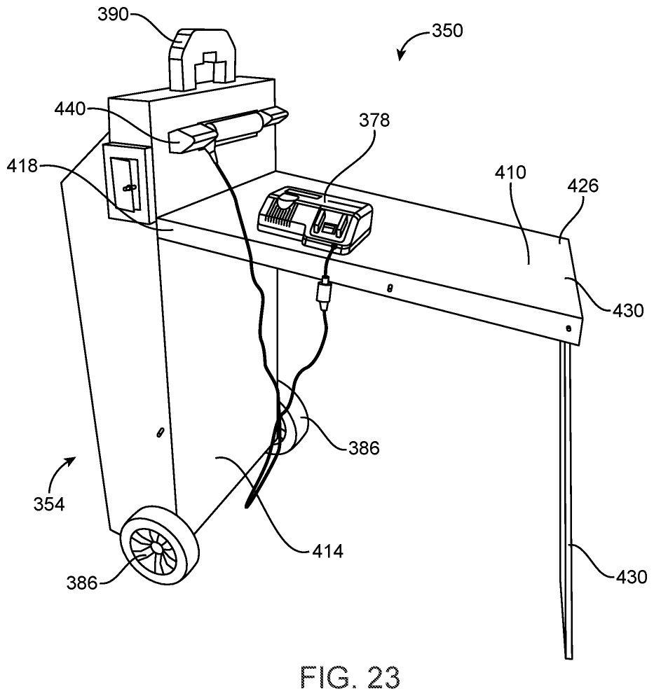

A table 410 is pivotally coupled to a back wall 414 of the base 358 at a first end 418 of the table 410. The table 410 is pivotable relative to the base 358 between a stowed position 422, where the table 410 is collapsed against the base 358, and an operating position 426, where the table 410 is pivoted away from the base 358. A leg 430 is pivotally coupled to the table 410 at a second end 434 opposite the first end 418. When the table 410 is in the operating position 426, the leg 430 of the table 410 is pivoted outward and engages the ground 436, thereby supporting the table 410 in the operating position 426 where the table 410 is substantially parallel to the ground 436. With reference to FIGS. 22-23, the table 410 may be used as an on-site work surface. For example, the table 410 may be used as an integrated BIM scan area 412 for digital blueprints, a support surface for making basic cuts or placement of an extra charging bay 378 for usage, etc.

The base 358 additionally includes a power strip 440 including pass-through outlets 442 and an integrated circuit breaker 444 that provide passthrough capabilities, that is, AC-powered tools and/or corded appliances may additionally or alternatively be used with the charging module 350. The charging module 350 includes a soft start capability, thereby preventing circuit overload while using high-draw AC-powered tools and/or accessories.

In another embodiment, a battery core 446 is supported in the cabinet 354. The battery core 446 is rechargeable and may be electrically coupled to the charging bays 378, the power strip 440 with pass-through outlets 442, or other components.

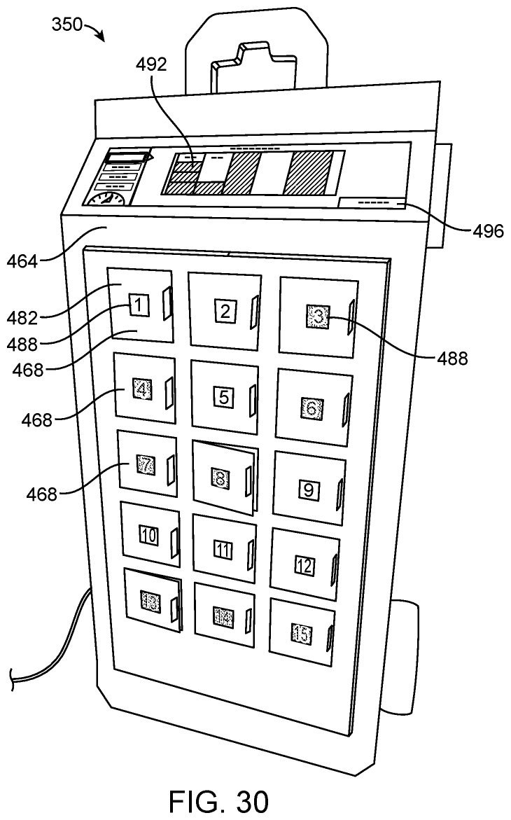

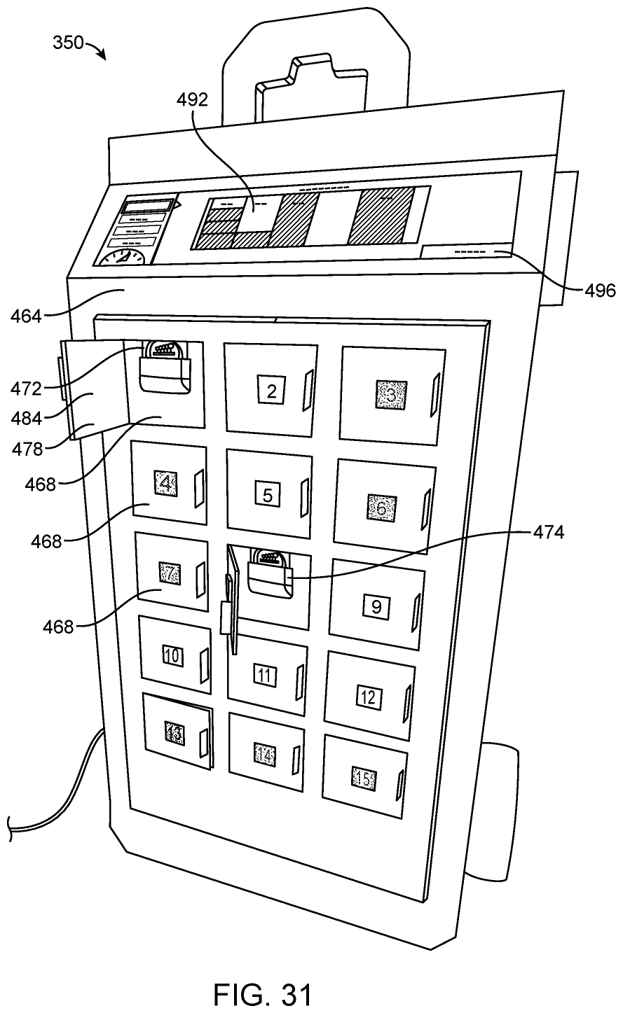

FIGS. 30-31 illustrate another embodiment of the charging module 350 for a work area. The charging module 350 has a base 464 that is generally rectangular and includes various compartments 468, or lockers, that extend into the base 464. In the illustrated embodiment, the charging module 350 includes fifteen compartments arranged in five rows with three compartments 468 per row, but other layouts and quantities of compartments may be used. A charging bay 472 for receiving a battery pack 476 (e.g., a power tool battery pack) is positioned in each of the compartments 468. Each of the compartments 468 include a door 478 that is pivotably coupled to the base 464, and each door 478 is individually pivotable between a closed position 482 and an open position 484. When the door 478 is in the closed position 482, the battery pack 474 is secured within the compartment 468 and protected from environmental factors (e.g., weather, dust, etc.). Each of the compartments 468 includes an indicator 488 positioned on the door 478. The indicator 488 is configured to emit a light indicative of a status (e.g., charging status, battery health, etc.) of the battery pack 474 positioned within the compartment 468.

The charging module 460 additionally includes a display panel 492. The display panel 492 monitors and displays various performance specifications (e.g., battery health, use time, locking status, charge level, etc.) of the battery packs 474 positioned within the compartments 468. When a battery pack 474 is positioned within the compartment 468 and the door 478 is in the closed position 482, the door 478 may be locked to prevent a user from opening the door 478. In some embodiments, the display panel 492 includes a security apparatus 496 which requires a user to verify their identification (e.g., via a code, etc.) in order to unlock the door 478.

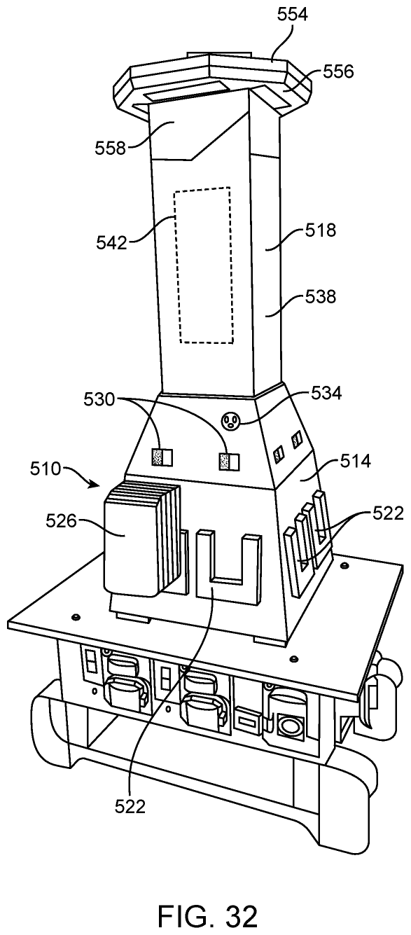

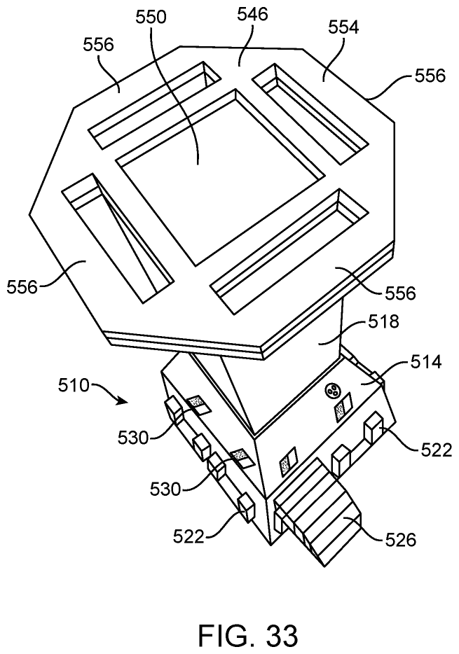

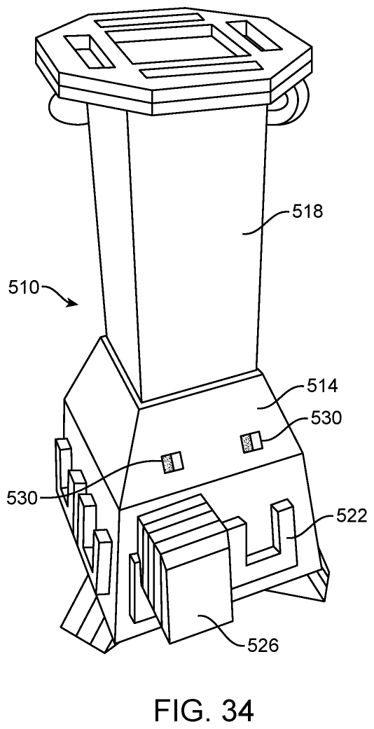

FIGS. 32-34 illustrate another embodiment of a charging module 510 for a work area. The charging module 510 includes a housing 514 and a light 518 coupled to and extending from the housing 514. The housing 514 is generally rectangular and includes charging bays 522 for receiving a battery pack 526 (e.g., a power tool battery pack). In the illustrated embodiment, the housing 514 includes eight charging bays 522 configured to receive 12-volt and/or 18-volt power tool battery packs 526. More specifically, two charging bays 522 are positioned on each side of the housing 514. The housing 514 includes a plurality of indicators 530, each indicator 530 disposed adjacent a charging bay 522. The indicators 530 are configured to emit light indicative of a status (e.g., charging status, battery health, temperature, etc.) of the battery pack 526 coupled to the charging bay 522. The housing 514 additionally includes two ports 534. In the illustrated embodiment, one of the ports 534 is a male AC plug 534a for receiving power to the charging module 510, and the other port 534 is a female AC pass-through port 538b for tethering the charging module 510 with other charging modules 510 and/or plugging in an AC-powered tool. However, in alternative embodiments, the housing 514 may include alternative types of ports.

The light 518 is an area light configured to emit light in a 360-degree range. The light 518 includes a diffuser 538 and a light source 542. The light source 542 is a single area light emitting diode (LED). However, in some embodiments, the light source 542 may include multiple LEDs. The diffuser 538, or lens, is supported by and extends upwardly from the housing 514. The light 518 is also configured to emit light in an upwards direction. Specifically, a top surface 546 of the light 518 includes a lens 550 allowing light to be directed upward. The light 518 may be powered via AC power when the charging module 510 is plugged in, or via two fully charged 18-Volt battery packs 526 docked in the charging bays 522. A handle 554 is positioned at an upper end 558 of the lens 550 of the light 518. Specifically, the handle 554 extends circumferentially around at least a portion of a perimeter of the light 518 and includes a plurality of grip portions 556 that are graspable by the user for support and/or transport of the charging module 510.

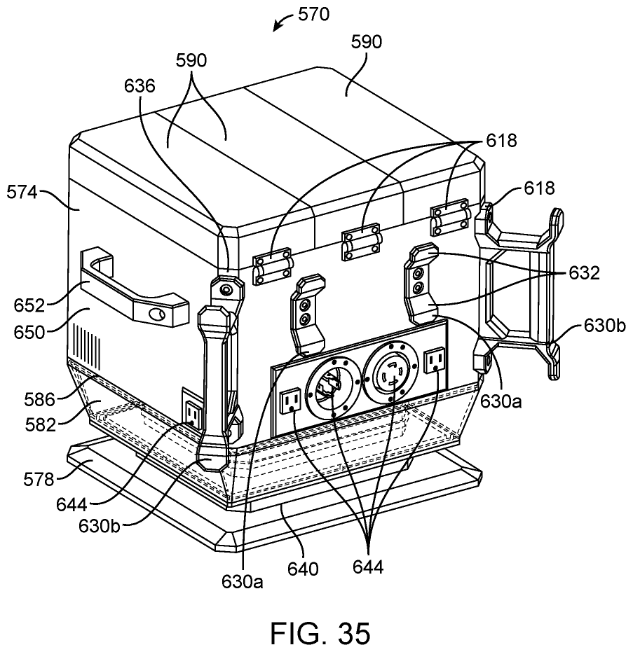

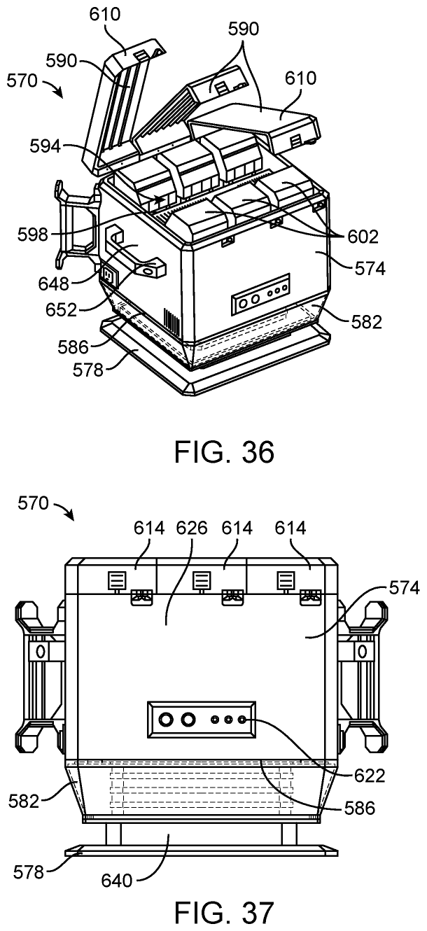

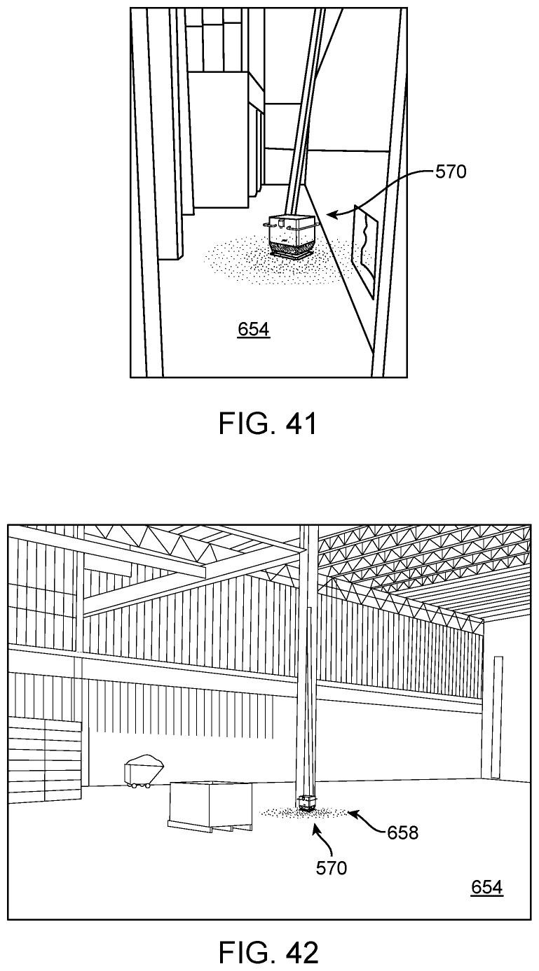

FIGS. 35-42 illustrate another embodiment of a charging module 570 for a work area. The charging module 570 includes a housing 574 supported by a base 578 and a light 582 positioned at a bottom portion 586 of the housing 574 between the housing 574 and the base 578. A plurality of doors 590 are pivotally coupled to the housing 574 to enclose the compartment 594 defined in the housing 574. A plurality of charging bays 598 for charging battery packs 602 (e.g., power tool battery packs) are positioned in the compartment 594. The illustrated embodiment includes six charging bays 598 for charging 12-volt and/or 18-volt battery packs 602, arranged in two rows with three charging bays 598 per row, but other quantities and capacities of battery packs 602 arranged in other layouts may be included instead. Each of the doors 590 are pivotable between an open position 610 and a closed position 614. When a door 590 is in the open position 610, a user can access some of the battery packs 602 coupled to charging bays 598. In the illustrated embodiment, the user can access two of the six battery packs 602. The doors 590 can be locked when in the closed position 614, for instance, with a padlock (not shown) or other locking mechanism. A spring 618 engages each of the doors 590 and biases each of the doors 590 to the open position 610 when the door 590 is not locked in the closed position 614. The housing 574 also includes status lights 622 disposed on a front side 626 of the housing 574 that emit a light indicative of the status (e.g. charging status, battery health, etc.) of the battery pack 602 coupled to the charging bay 598.

With further reference to FIG. 35, a plurality of cord wraps 630 having upper and lower extensions 632 are coupled to and extend from the housing 574. A first pair of cord wraps 630a, small cord wraps, are coupled to a rear side 634 of the housing 574. An external cord (not shown) can be wrapped about the first pair of cord wraps 630a for storage. A second pair of cord wraps 630b, large cord wraps, extend outwardly from the rear edges 636 defining the rear side 634. An external cord (not shown), for instance, a cord having a smaller gauge (that is, a larger diameter) or longer length, can be wrapped about the second pair of cord wraps 630b. The charging module 570 may include fewer or more cord wraps, cord wraps coupled to other surfaces of the housing 574, or cord wraps shaped/sized to accommodate different cords. The base 578 defines a cord wrap portion 640 around which a cord (not shown) can be wrapped to provide storage of the cord (not shown).

The housing 574 includes a plurality of receptacles 644 positioned on the rear side 634, left side 648, and right side 650 of the charging module 570. The receptacles 644 are configured to connect to various electrical cords. As illustrated in the present embodiment, the plurality of receptacles 644 include four 110-volt AC pass-through receptacles, however other quantities of pass-through receptacles may be included. The illustrated embodiment further includes a 220-volt input/pass-through receptacle to allow a user to electrically couple together via “daisy chain” a plurality of charging modules 570, including a quantity of charging modules 570 equal to a greater than fifteen. A pair of handles 652 extend from the left and right sides 648, 650 of the housing 574 for a user to grasp to transport the charging module 570.

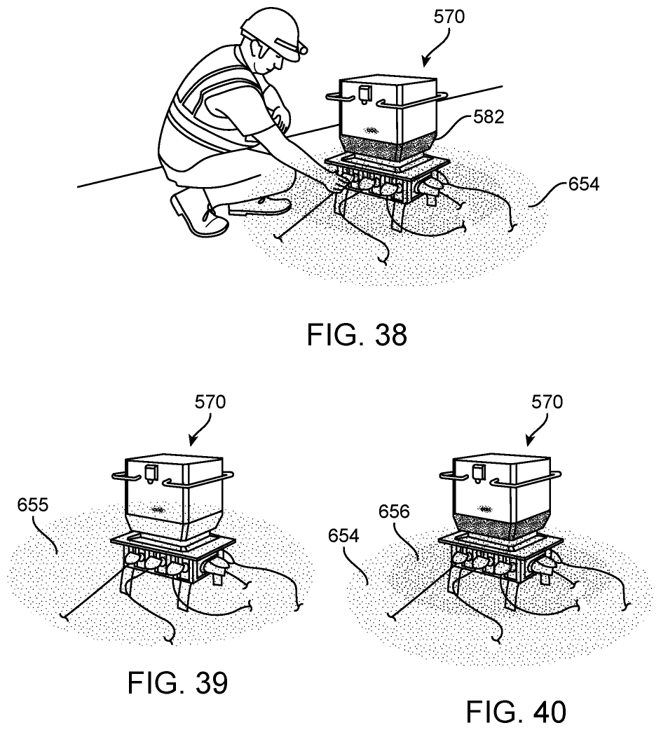

As illustrated in FIGS. 38-42, the light 582 is a directional floor light configured to emit light in a 360-degree range and direct the light toward the floor 654 for illuminating hazards. The light 582 may change from a first light color 655 providing ambient lighting to a second color 656 indicative of the presence of a hazardous condition, such as tripping hazards or wet floor conditions. The light 582 may instead change to a green color 658 indicative of completion of battery charging. The light 582 is powered by, for instance, AC power coupled to the receptacles 644 or DC power from battery packs 602 coupled to the charging bays 598.

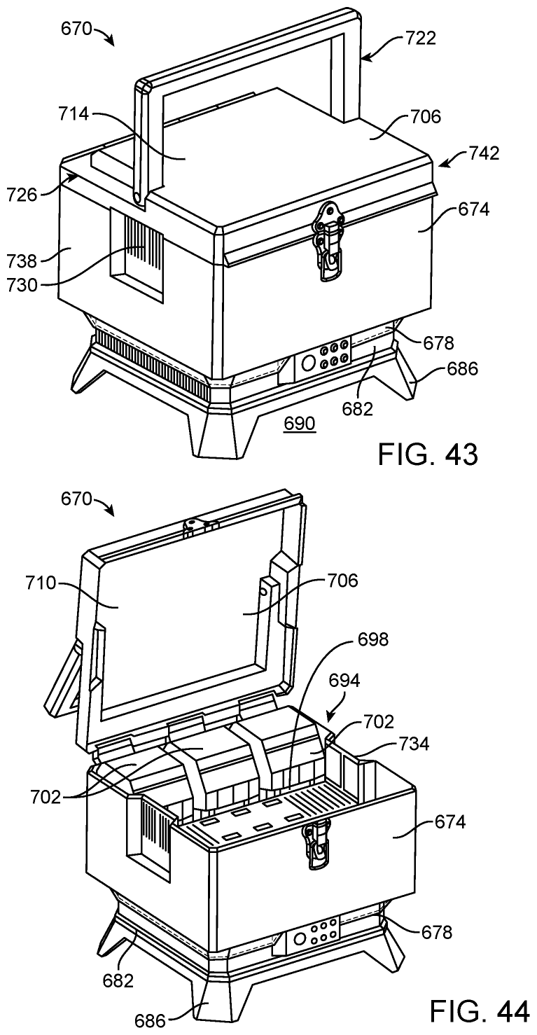

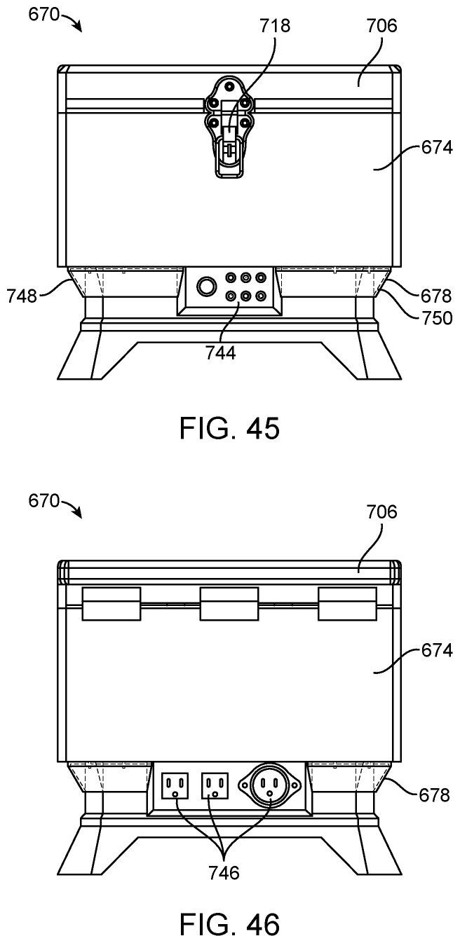

FIGS. 43-46 illustrate another embodiment of a charging module 670 for a work area. The charging module 670 includes a housing 674 and a light 678 supported by the housing 674. The base 682 includes a plurality of feet 686 configured to support the charging module 670 on a work surface 690. The housing 674 defines a compartment 694 in which a plurality of charging bays 698 are positioned. The charging bays 698 are configured to receive battery packs 702 (e.g., power tool battery packs) such as 18-volt and/or 12-volt capacity battery packs. The illustrated embodiment includes six charging bays 698, but other quantities may be included. A lid 706 is pivotally coupled to the housing 674 and encloses the compartment 694. The lid 706 is pivotable between a first, open position 710 and a second, closed position 714. The charging module 670 includes a latch 718 which may be engaged by a padlock (not shown) or other lock for securing the lid 706 in the closed position 714. A handle 722 is pivotally coupled to the lid 706 for providing a grip by which a user can carry the charging module 670. The lid 706 defines a handle receptacle 726 in which the handle 722 is received for storage flush with the lid 706. Left and right side handles 730, 734 extend into the left and right sides 738, 742 of the housing 674 adjacent the lid 706.

The housing 674 also includes a plurality of ports 746 configured to connect electrical cords. The illustrated embodiment includes a 110-volt AC input receptacle and two 110-volt AC pass-through outlets configured to electrically couple power tools or other apparatuses that use 110-volt AC power to the charging module 670. Other ports 746 receiving different connectors may be used instead. The housing 674 also includes status light 744 that indicate a status (e.g. battery health, charging status, etc.) of the battery packs 702 coupled to the charging bays 698.

The light 678 is a directional floor light configured to emit light in a 360-degree range directed toward the floor for illuminating hazards. The light 678 of the illustrated embodiment includes first and second light portions 748, 750 that each extend at least partially about the housing 674.

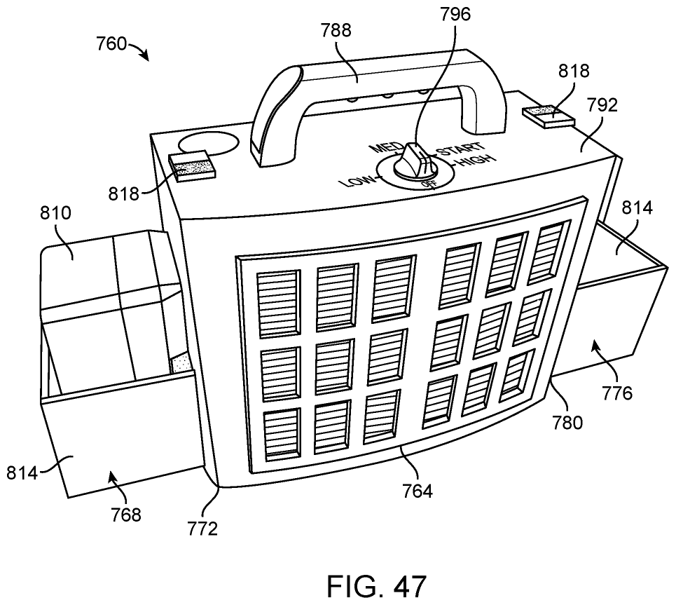

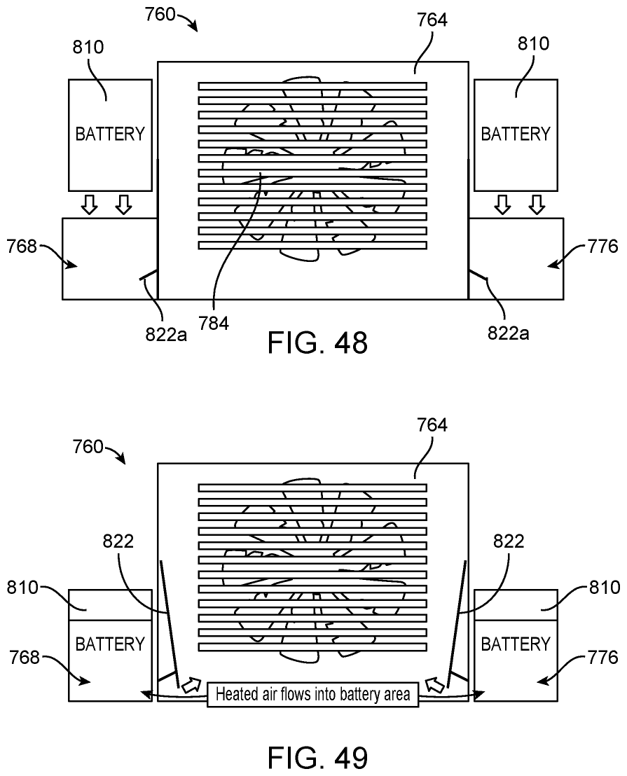

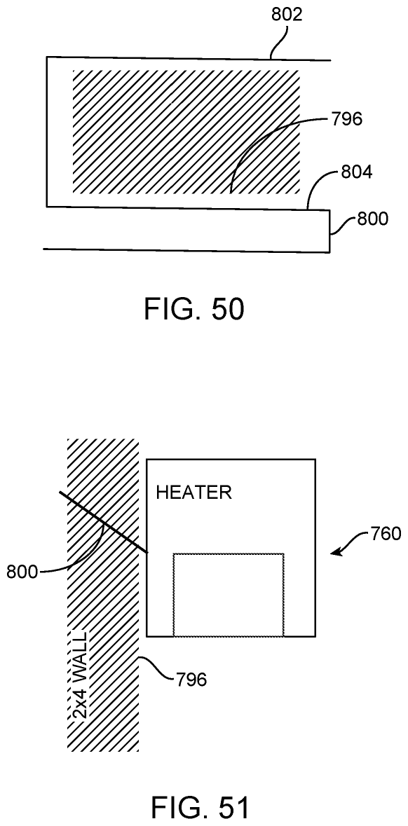

FIGS. 47-51 illustrate another embodiment of a charging module 760 for a work area. The charging module 760 includes a heating unit 764, a first charging bay 768 coupled to a first end 772 of the heating unit 764, and a second charging bay 776 coupled to a second end 780 of the heating unit 764 that is opposite the first end 772. The heating unit 764 is a fan-driven, electric heating unit 764 including a heating element 784 configured to generate heat or cool air. A handle 788 is coupled to an upper surface 792 of the heating unit 764 and is graspable by the user for support and/or transport of the charging module 760. The heating unit 764 additionally includes a user interface 796 (e.g., a dial) for operating the heating unit 764 in a plurality of different modes (e.g., a high mode, a medium mode, a low mode). In some embodiments, the charging module 760 includes a hook 800 configured to hang and/or mount the charging module 760 on a surface 798, such as a wall or a 2×4 stud. The hook 800 is generally S-shaped, with first and second gripping portions 802, 804 configured to engage the surface 798.

The first and second charging bays 768, 776 are configured to receive a battery pack 810 (e.g., a power tool battery pack). In the illustrated embodiment, the charging bays 768, 776 are configured to receive an 18-volt power tool battery pack and/or a 12-volt power tool battery pack. The charging bays 768, 776 are shaped and sized to surround the battery packs 810, thereby protecting the battery packs 810 from damage and holding heat around the battery packs 810. A cover 814 may be coupled to the charging bays 768, 776. The heating unit 764 includes indicators 818. Specifically, the heating unit 764 includes a first indicator 818a adjacent the first charging bay 768 and a second indicator 818b adjacent the second charging bay 776. The indicators 818 are configured to emit light indicative of a charge status of the battery pack 810 positioned within the charging bay 768, 776.

A trap door 822 including an engagement portion 822a is positioned in the heating unit 764 adjacent the charging bays 768, 776. When a user inserts a battery pack 810 into the first charging bay 768 and/or the second charging bay 776, the battery pack 810 engages the engagement portion 822a and pushes open the adjacent trap door 822 within the charging bay 768, 776, thereby allowing heat/air from the heating unit 764 to pass through the battery pack(s) 810. As such, the battery pack(s) 810 are heated and/or cooled via the heating unit 764.

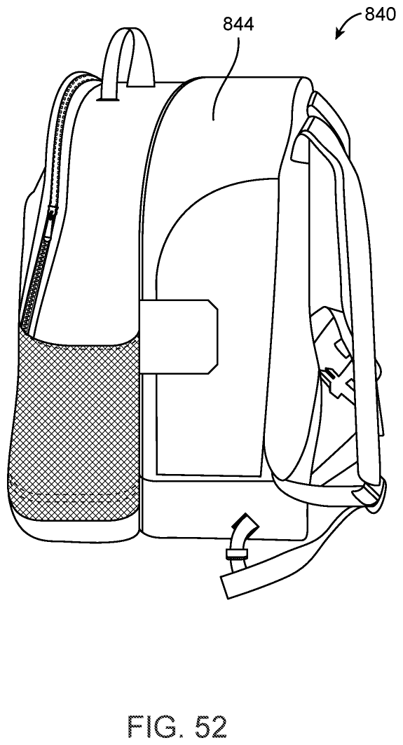

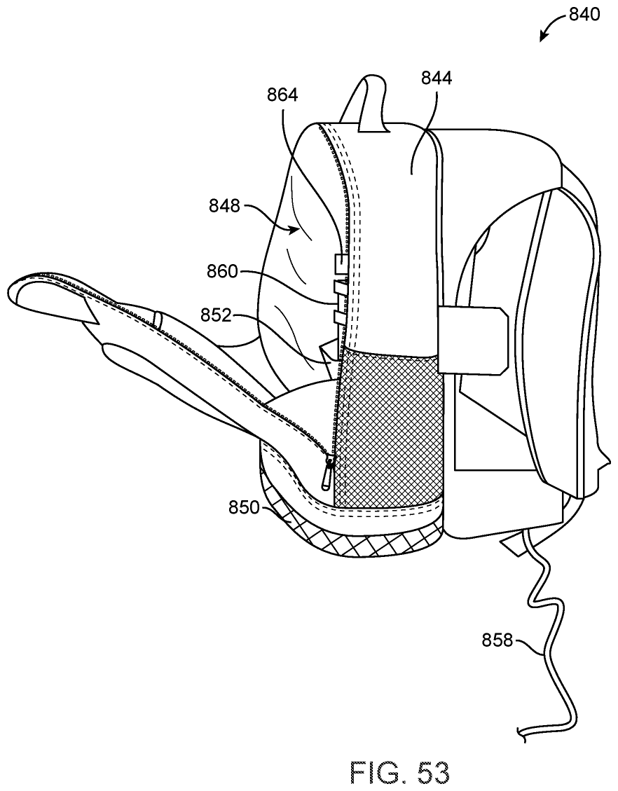

FIGS. 52-53 illustrate another embodiment of a charging module 840 for a work area. The charging module 840 includes a flexible bag 844 (e.g., a backpack) having an inner storage compartment 848. The storage compartment 848 includes charging bays 852 configured to receive a battery pack 856 (e.g., a power tool battery pack). In the illustrated embodiment, the storage compartment 848 includes four AC-powered charging bays configured to receive an 18-volt power tool battery pack and/or a 12-volt power tool battery pack. A cord 858 electrically coupled to the charging bays 852 may be stored within the storage compartment 848 of the bag 844. The cord 858 is extendable from the flexible bag 844. The cord 858 may be stored in the storage compartment 848, the base 850, or other compartments of the flexible bag 844. The charging bays 852 positioned within the storage compartment 848 allow a user to charge battery packs 860 during storage and/or travel.

The storage compartment 848 additionally includes at least one charging port 864. In the illustrated embodiment, the charging port 864 is a USB port, although other suitable charging ports may also or alternatively be included is the charging module 840.

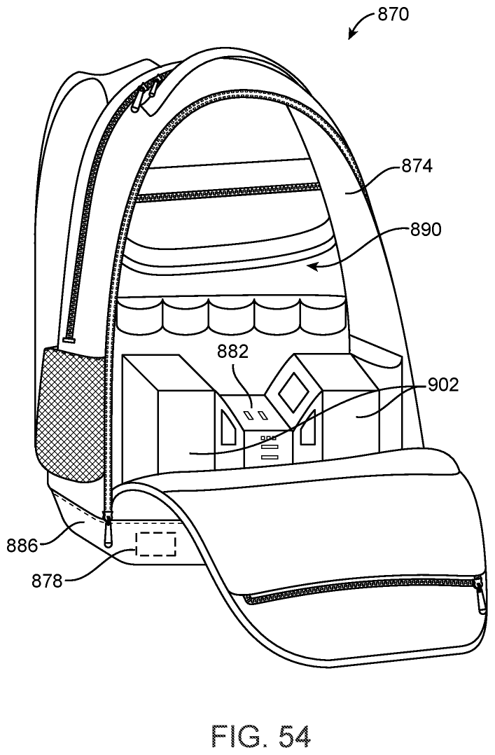

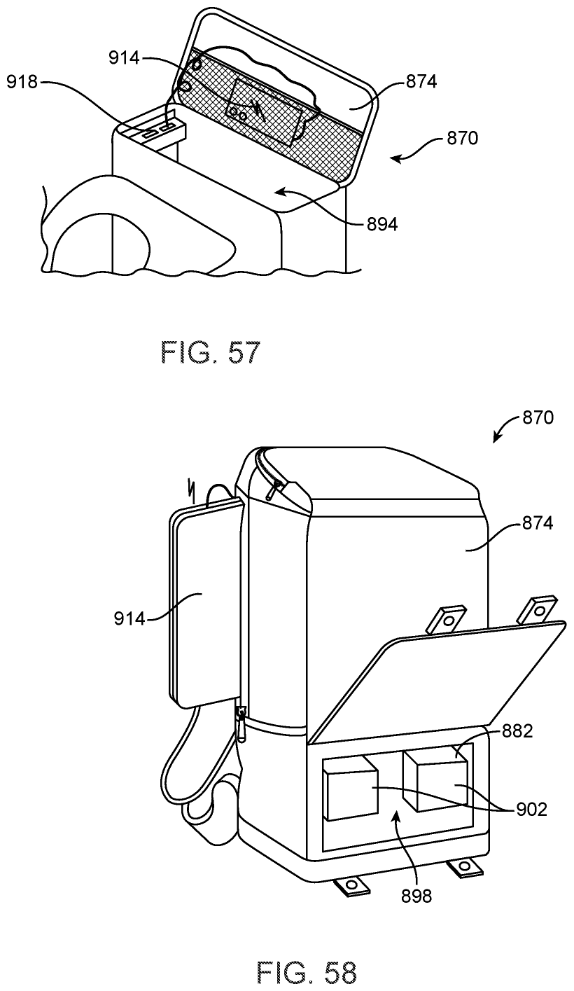

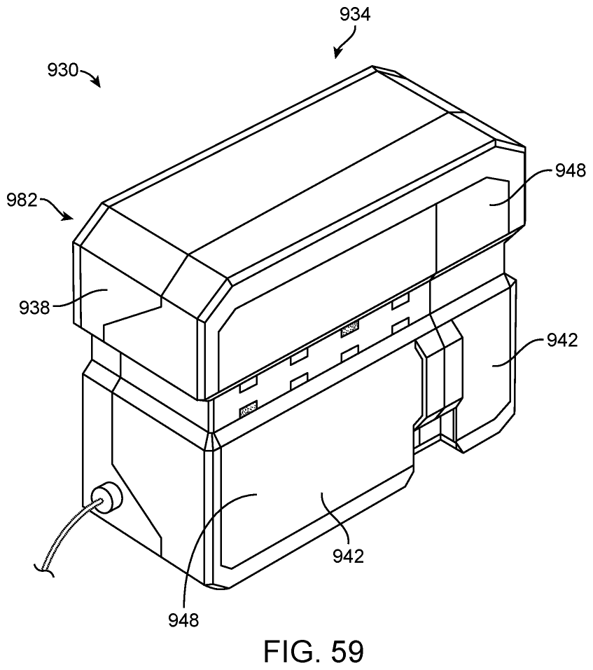

FIGS. 54-58 illustrate another embodiment of a charging module 870 for a work area. The charging module 870 includes a flexible bag 874 (e.g., a backpack) having a power supply 878 and at least one charging bay 882 disposed in a storage compartment 880 of the bag 874. The power supply 878 is positioned in the bag 874 remotely from the charging bay 882 thereby providing additional space for tools or other equipment. As illustrated in FIG. 54, the power supply 878 may be stored in the base 886 of the bag 874 and electrically coupled to the charging bay 882 disposed in a main compartment 890. As illustrated in FIGS. 57-58, the power supply 878 may be disposed in an upper compartment 894 and a pair of charging bays 882 are disposed in a lower compartment 898 separated from the upper compartment 894. The charging bays 882 are configured to receive a battery pack 902 (e.g., a power tool battery pack). In the illustrated embodiment, the charging module 870 is configured to receive two 12-volt and/or 18-volt power tool battery packs. A cord 906 electrically coupled to the charging bays 882 may additionally be stored within any of the compartments of the bag 874. The charging bays 882 positioned within the storage compartment 880 allow a user to charge various battery packs 902 during storage and/or travel. The charging bays 882 have a low-profile interface 910 configured for compact placement in the bag 874.

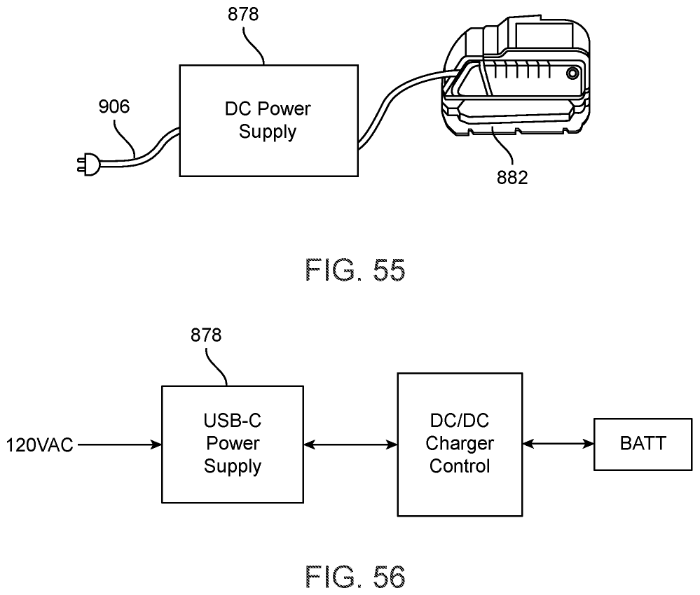

In a first illustrated embodiment shown in FIG. 55, the power supply 878 is a DC power supply 878a. The DC power supply 878a is electrically coupled to 120-volt AC mains power, for instance, by an electrical cord 906, for recharging the DC power supply 878a. The charging bays 882 are electrically coupled to the DC power supply 878a and receive DC power from the DC power supply 878a.

In a second illustrated embodiment shown in FIG. 56, the power supply 878 is a bi-directional USB power supply 878b that can be electrically coupled to 120-volt AC mains power by an electrical cord 906. Specifically, the USB power supply 878b is electrically coupled to the charging bays 882 and can additionally, or alternatively, be coupled to other devices 914 requiring a power supply, for instance, for charging. The USB power supply 878b includes at least one port 918 configured to receive a USB connector and electrically couple a device 914, such as a cell phone or tablet, to the USB power supply 878b.

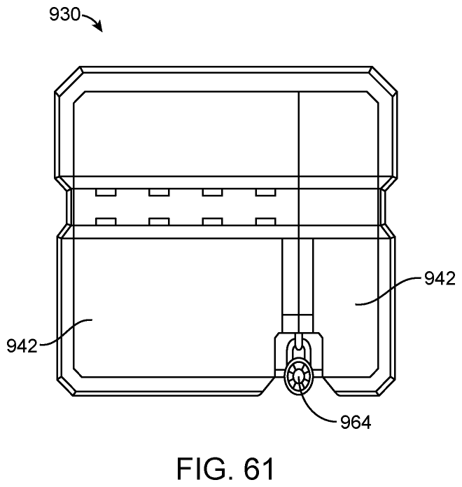

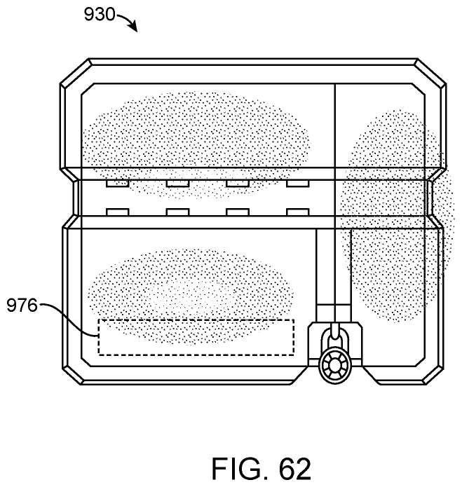

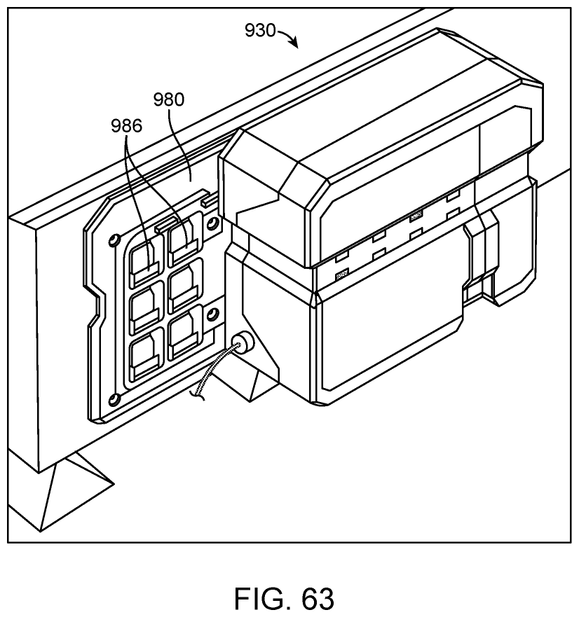

FIGS. 59-64 illustrate another embodiment of a charging module 930 for a work area. The charging module 930 is an enclosure 934 formed of a base 938 and a pair of doors 942 pivotable relative to the base 938 between an open position 946 and a closed position 948. The pair of doors 942 may instead be a single door that is pivotable relative to the base 938. The base 938 is generally rectangular and defines an internal chamber 952 including charging bays 956 configured to receive a battery pack 960 (e.g., a power tool battery pack). In the illustrated embodiment, the chamber 952 includes eight charging bays 956 configured to receive 18-volt power tool battery packs and/or a 12-volt power tool battery packs. With reference to FIG. 61, the doors 942 are engageable by a padlock 964. When the doors 942 are in the closed position 948, the padlock 964 engages and locks the doors 942 relative to the base 938, thereby preventing access to the internal chamber 952.

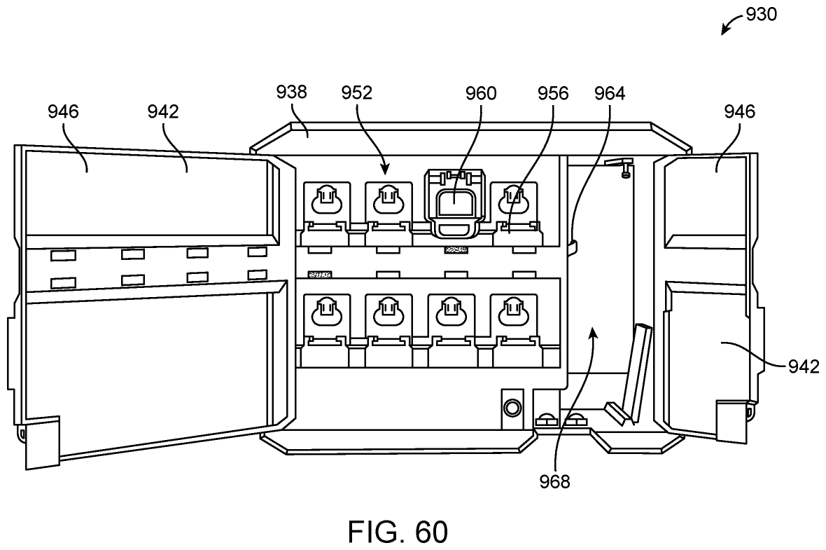

Returning with reference to FIG. 60, the chamber 952 additionally includes charging ports 968 and a storage compartment 972. In the illustrated embodiment, the chamber 952 includes four USB ports, although other suitable charging ports may additionally or alternatively be included on the charging module 930. The storage compartment 972 is shaped and sized to store small tools and accessories. A heater 976 is supported in the base 938. The heater 976 provides heat to the battery packs 960, preventing the charging module 930 from having operating issues when exposed to harsh weather conditions. A fan (not shown) may be supported in the base 938 for moving heated air about the internal chamber 952. A mounting plate 980 is coupled to a back surface 982 of the base 938, for instance, in a sliding manner. The mounting plate 980 includes mounting interfaces 986 (e.g., grooves and/or apertures). The mounting plate 980 is configured to mount the charging module 930 to a work surface and/or wall of a worksite.

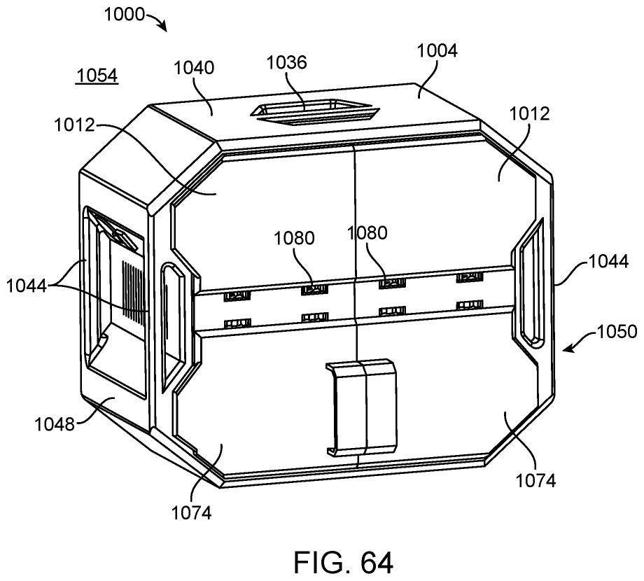

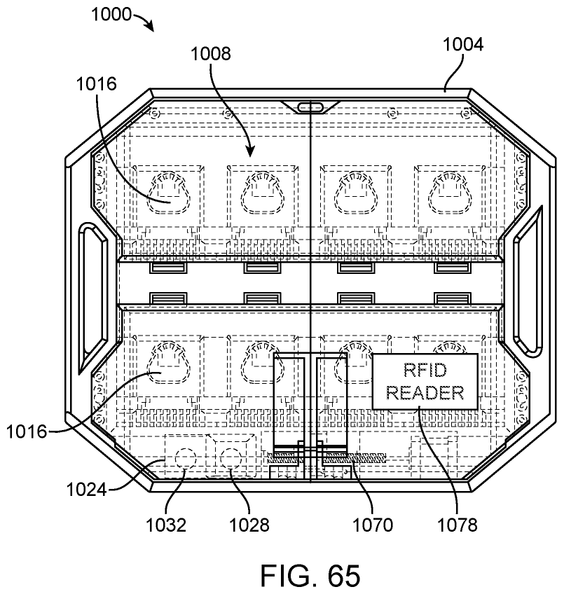

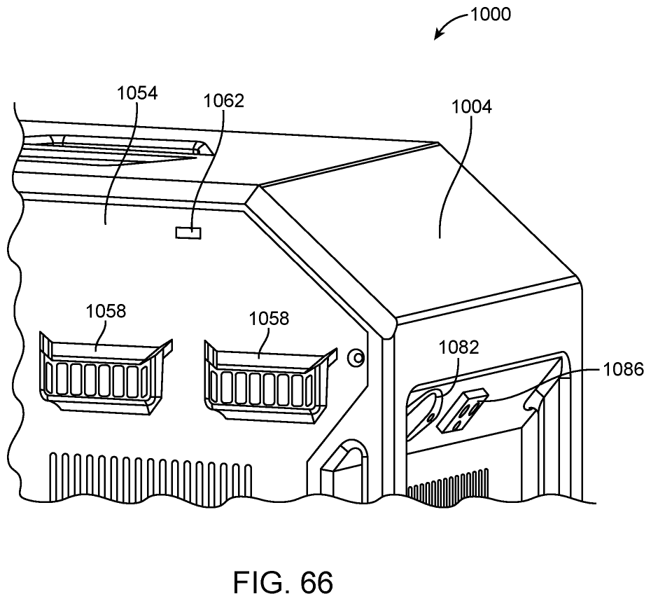

FIGS. 64-66 illustrate another embodiment of a charging module 1000 for a work area. The charging module 1000 includes a housing 1004 that is generally hexagonal and defines an interior compartment 1008. A pair of doors 1012 are pivotally coupled to the housing 1004. The interior compartment 1008 includes charging bays 1016 configured to receive a battery pack 1020 (e.g., a power tool battery pack). In the illustrated embodiment, the compartment 1008 includes eight charging bays 1016 configured to receive an 18-volt power tool battery pack and/or a 12-volt power tool battery pack. A heating element 1024 is supported in the housing 1004 and is configured to heat the interior compartment 1008 during cold weather usage. A fan (not shown) may be supported in the housing 1004 for moving air about the interior compartment 1008. A switch 1028 is positioned in the interior compartment 1008 for turning the heating element 1024 on and off. The charging module 1000 additionally or alternatively includes a temperature sensor 1032 configured to activate the heating element 1024, for instance, when the ambient temperature is below a threshold temperature.

The housing 1004 has a handle 1036 defined in the top surface 1040. Side handles 1044 extend in a generally vertical direction along opposite left and right sides 1048, 1050 of the housing 1004. A rear face 1054 of the charging module 1000 opposite the pair of doors 1012, includes mounting features 1058, such as cleats, configured to interface with mounting features of a modular storage system. The rear face 1054 also includes a slot 1062 that communicates the interior compartment 1008 through which a locking feature 1066 (e.g., a hook, clip, etc.) can extend. A locking feature (not shown) extending into the interior compartment 1008 for locking the charging module 1000 and preventing its removal can by engaged by a lock (not shown), such as a padlock, that engages the locking feature. The lock may instead be integrated with the housing 1004. The pair of doors 1012 also include a door lock 1070 to secure the doors 1012 in a closed position 1074. The door lock 1070 includes an RFID reader 1078 configured to provide inventory management of the battery packs 1020 charged by the charging bays 1016. A plurality of indicators 1080 which indicate the status of battery packs 1020 coupled to the charging bays 1016 may be supported on the doors 1012

The housing 1004 includes a power inlet 1082 and a pass-through outlet 1086 positioned on the left side 1048 of the housing 1004. The power inlet 1082 is configured to receive an AC power supply via an electrical cord (not pictured). A tool (not shown), such as an AC power tool, can receive a power supply, such as a 110-volt power supply, via the pass-through outlet 1086.

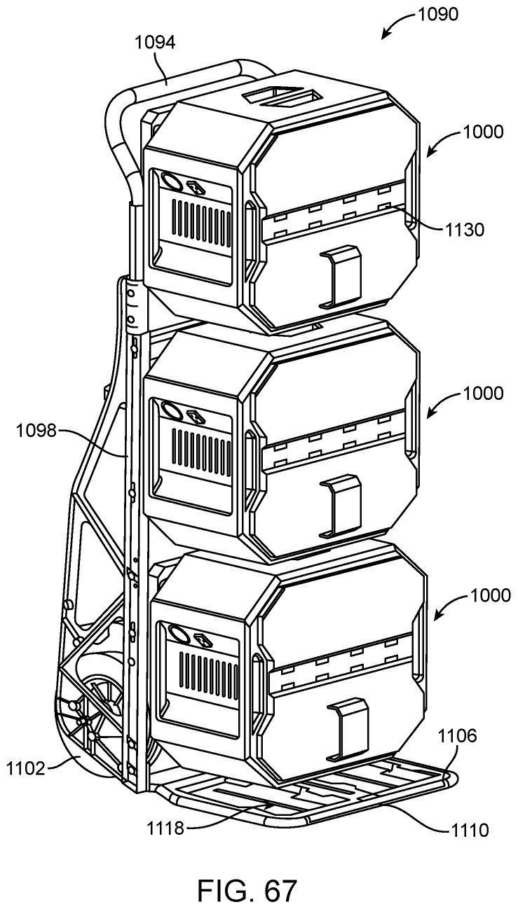

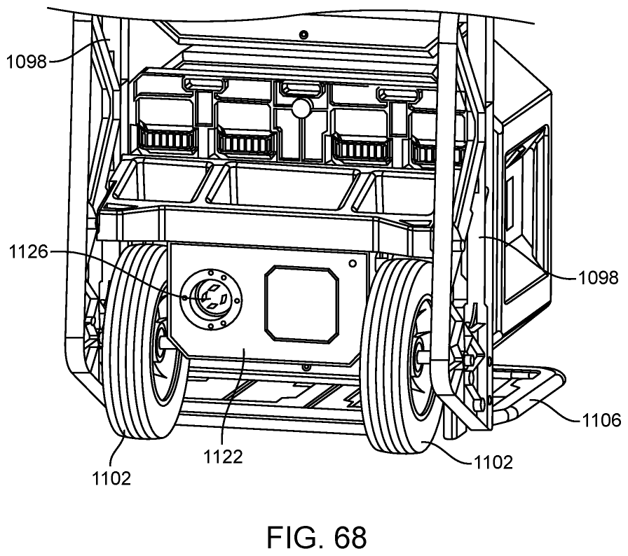

With reference to FIGS. 67-68 the charging modules 1000 may be incorporated into a charging system 1090. The charging system 1090 includes a dolly 1094 to which a plurality of charging modules 1000 are coupled. In the illustrated embodiment, three charging modules 1000 are coupled to the dolly 1094 in a generally vertical arrangement. Other arrangements and quantities of charging modules 1000 can be coupled to the dolly 1094. The dolly 1094 has a pair of rails 1098 to which a pair of wheels 1102 are coupled. A platform 1106 is pivotally coupled to and extends from the rails 1098 away from the wheels 1102. The platform 1106 can pivot from an extended position 1110 having an angle of about 90 degrees relative to the rails 1098 to a stored position 1114 adjacent to and generally parallel to the rails 1098. The platform 1106 includes mounting features 1118 configured to interface with the mounting features (not shown) of a modular storage system (not shown). A panel 1122 is coupled to the rails 1098 between the wheels 102 adjacent the platform 1106. The panel 1122 includes an inlet 1126 to which a power supply (not shown), such as a 220-volt AC power supply, can be coupled. The charging modules 1000 are electrically coupled to the panel 1122 and receive power from the panel 1122 and can output power, such as 110-volt AC power, via the pass-through outlets 1086.

In the illustrated embodiment, the compartment 1008 of each of the charging modules 1000 include eight charging bays 1016 configured to receive an 18-volt power tool battery pack and/or a 12-volt power tool battery pack and the charging system 1090 includes twenty-four charging bays 1016 in total. The charging modules 1000 can be secured to the dolly 1094 via the locking features 1066. The charging system 1090 includes an inventory management system 1130, such as an RFID inventory management system.

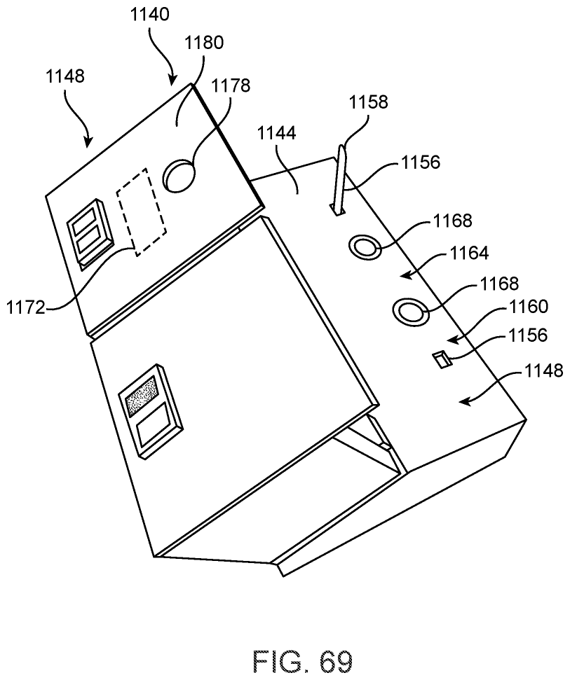

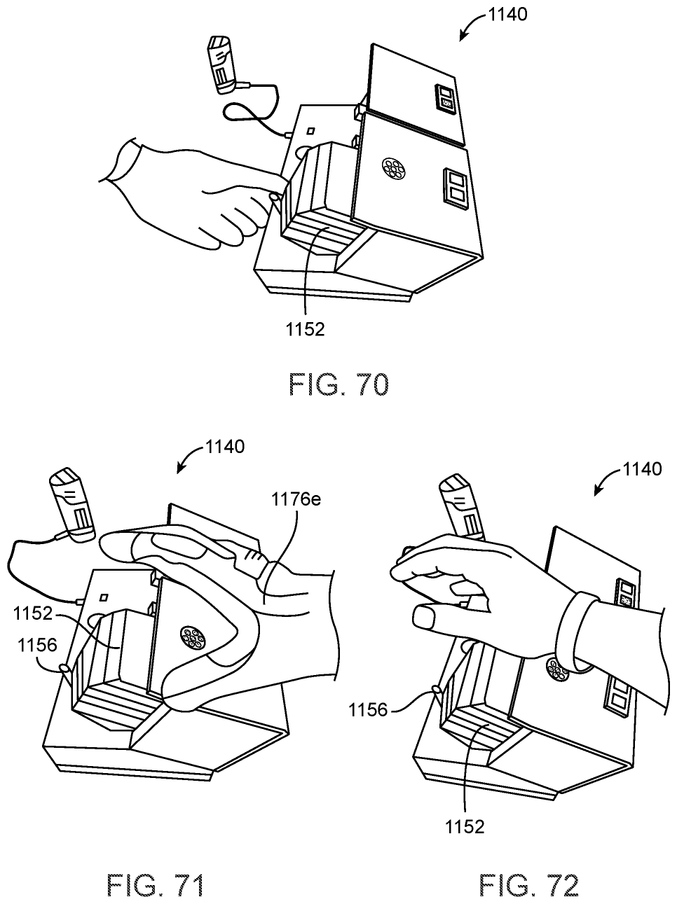

FIGS. 69-77 illustrate another embodiment of a charging module 1140 for a work area. The charging module 1140 includes a base 1144 having various charging bays 1148 configured to receive a battery pack 1152 (e.g., a power tool battery pack). In the illustrated embodiment, the base 1144 includes two charging bays 1148 configured to receive an 18-volt power tool battery pack 1152. The base 1144 includes a plurality of locking features 1156 corresponding with each of the charging bays 1148 configured to lock the battery packs 1152 relative to the charging bays 1148. The locking feature 1156 is movable between an extended position 1158 and a retracted position 1160. In the extended position 1158, the locking feature 1156 protrudes from the base 1144 and extends upward toward the charging bays 1148.

The base 1144 additionally includes a user interface 1164 having actuators 1168, for instance, a first actuator and second actuator. The actuators 1168 are depressible by the user to send a request to use the charging bays 1148. Specifically, the first actuator 1168 is associated with one of the charging bays 1148 and the second actuator 1168 is associated with the other of the charging bays 1148.

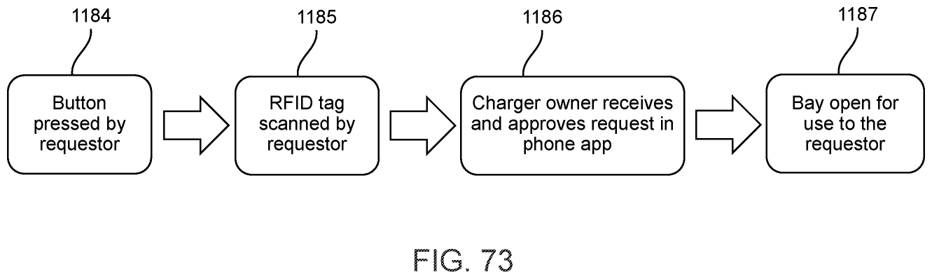

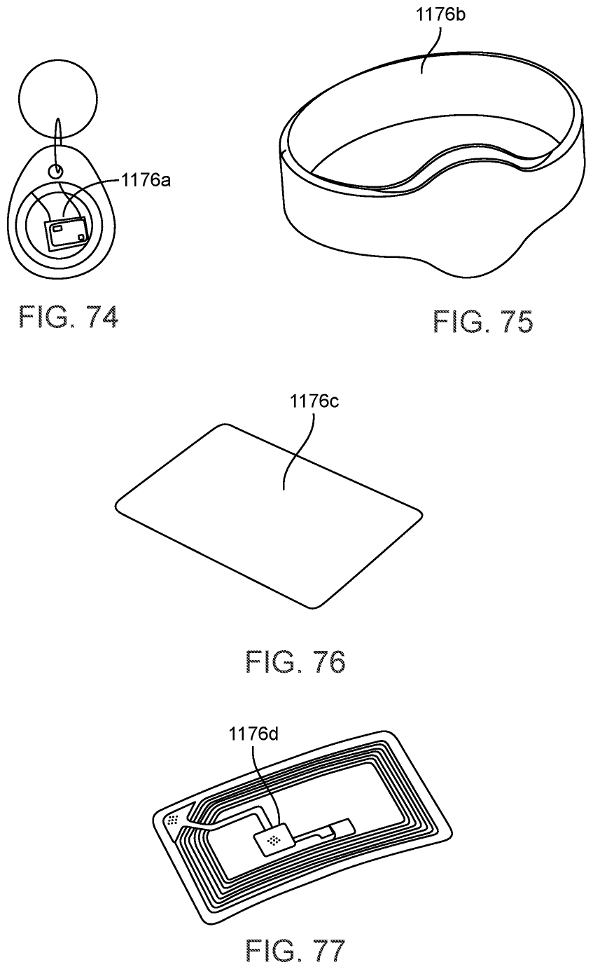

The base 1144 is additionally embedded with an identification tag reader 1172 (e.g., configured to read an RFID tag). The identification tag reader 1172 prevents removal of battery packs 1152 from the charging bays 1148 without identification. In order to remove a battery pack 1152 from a charging bay 1148, the user actuates the first or second actuator 1168. The user scans a personal item (e.g., a keychain fob 1176a, a bracelet 1176b, a card 1176c, an adhesive tag 1176d, a glove 1176e, etc., shown in FIGS. 74-77) including a corresponding identification tag 1176 (e.g., an RFID tag) on the base 1144. Upon identification of the user via the correct identification tag 1176 (illustrated in FIG. 71 as a glove 1176e), the locking feature 1156 unlocks the battery pack 1152 from the charging bay 1148. Specifically, the locking feature 1156 moves from the extended position 1158 to the retracted position 1160, thereby allowing a user to remove the battery pack 1152 from the base 1144. If an incorrect identification tag 1176 (illustrated in FIG. 72 as a bracelet 1176b) is used, the locking feature 1156 does not unlock the battery pack 1152 from the charging bay 1148, thereby preventing the user from removing the battery pack 1152. An indicator light 1178 on a top surface 1180 of the charging module 1140 may provide a visual indication via a different light color whether the battery pack 1156 can be removed. With reference to FIG. 73, in order to share the charging bay 1148, in a first step 1184, a user depresses the corresponding actuator 1168 for the charging bay 1148 and in a second step 1185, scans the identification tag 1176 to confirm identity. In a third step 1186, a request to use the charging bay 1148 is sent to the owner of the charging module 1140 who can approve or deny the request using a handheld electronic device such as a mobile phone. In a fourth step 1187, upon approval, the charging bay 1148 can be used by the user, that is, the locking feature 1156 moves from the extended position 1158 to the retracted position 1160.

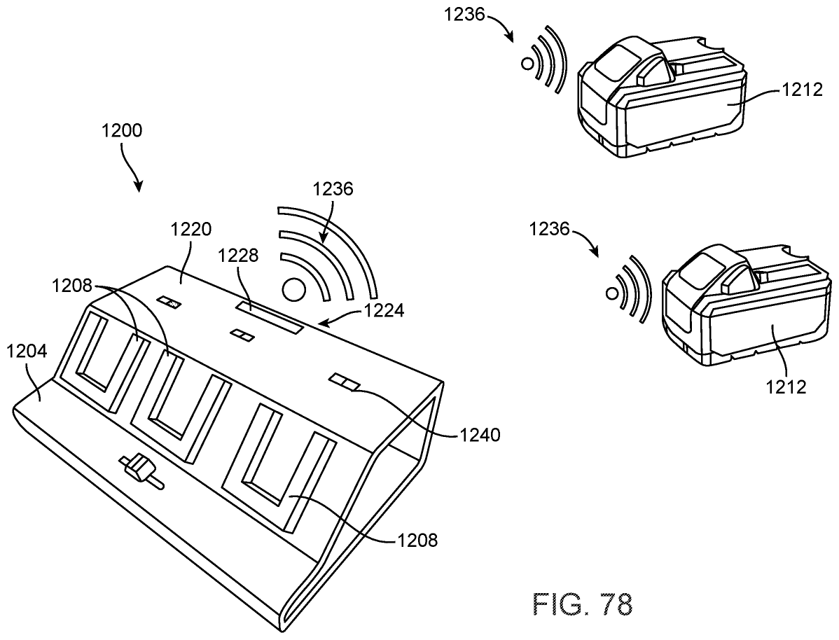

FIG. 78 illustrate another embodiment of a charging module 1200 for a work area. The charging module 1200 includes a base 1204 having a plurality of charging bays 1208 configured to receive a battery pack 1212 (e.g., a power tool battery pack). In the illustrated embodiment, the base 1204 includes three charging bays 1208 configured to receive an 18-volt power tool battery pack. The charging bays 1208 may instead receive other size/capacity battery packs. The base 1204 includes a locking feature (not shown) configured to lock the battery packs 1212 relative to the charging bays 1208.

An upper surface 1220 of the base 1204 includes a user interface 1224 having at least one actuator 1228 configured as a battery location feature 1232. When a user depresses the actuator 1228, a signal 1236 is emitted from the charging module 1200 to locate any missing battery packs 1212 synced with the charging module 1200. The battery packs 1212 receive the signal 1236, which is configured to assist a user in locating missing battery packs 1212 on a jobsite, for instance, via a map with a location viewable on a mobile device (not shown). The upper surface 1220 also includes a plurality of indicator lights 1240 that emit a light indicative of the status (e.g., charging status, battery pack health, etc.) of the battery pack 1212 coupled to the charging bay 1208.

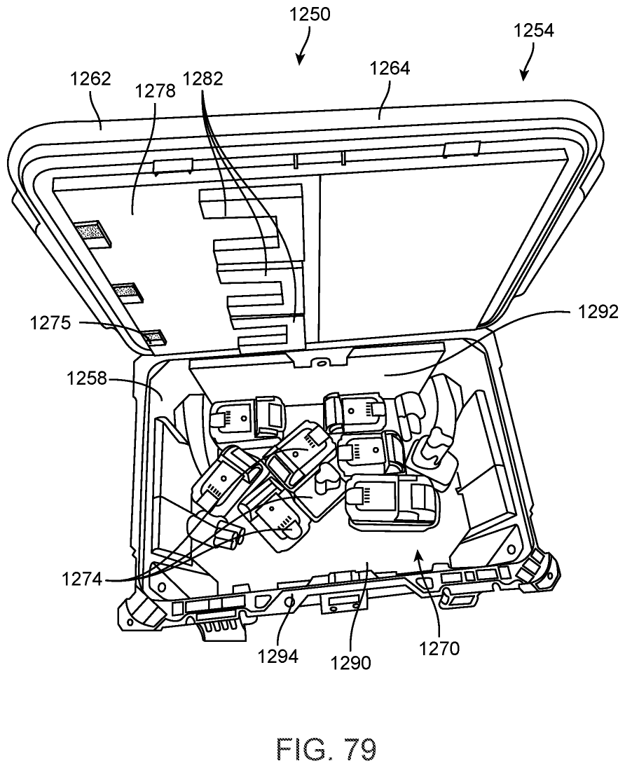

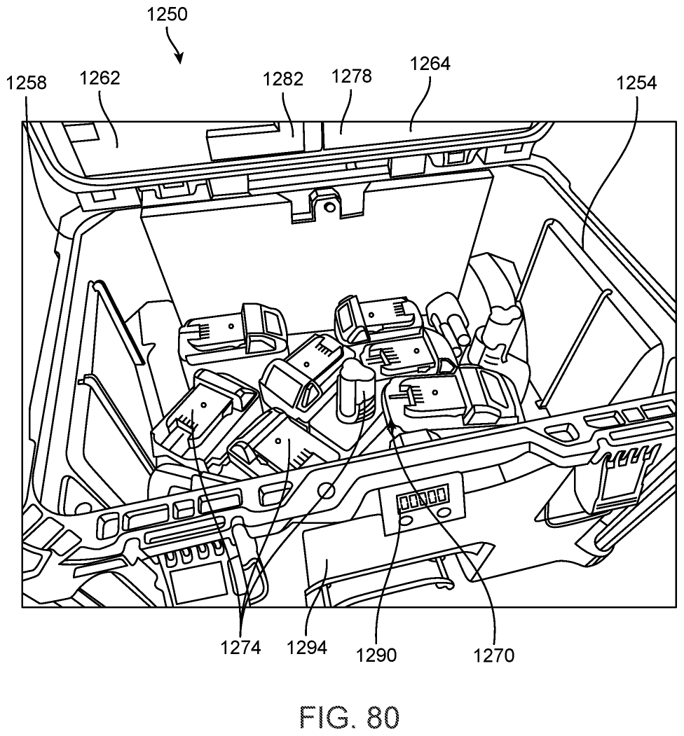

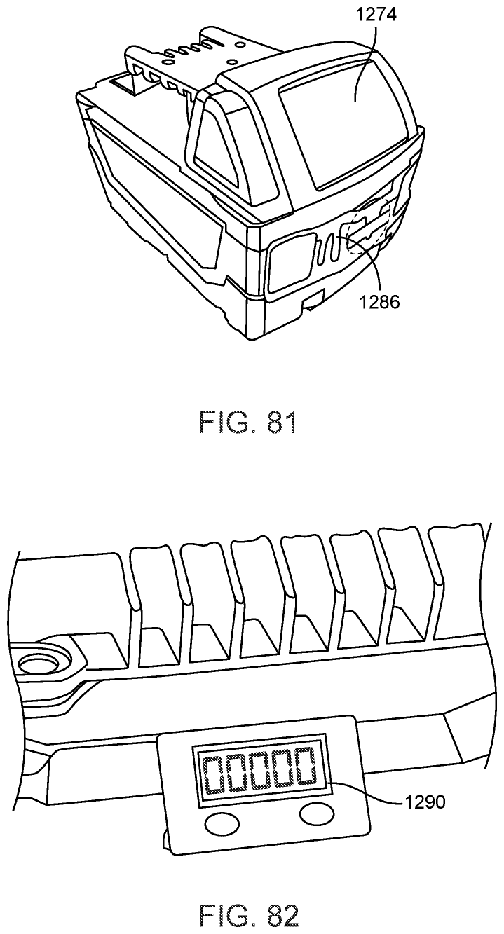

FIGS. 79-82 illustrate another embodiment of a charging module 1250 for a work area. The charging module 1250 is configured as a storage box 1254 including a main body 1258 and a lid 1262 that is pivotable relative to the main body 1258 between an open position 1264 and a closed position 1266. An internal chamber 1270 of the main body 1258 provides storage space for various tools (not shown), battery packs 1274, accessories (not shown), etc. An inner surface 1278 of the lid 1262 includes various charging bays 1282 configured to receive a battery pack 1274 (e.g., a power tool battery pack). In the illustrated embodiment, the lid 1262 includes three charging bays 1282 configured to receive an 18-volt power tool battery pack and/or a 12-volt power tool battery pack. Due to the position of the charging bays 1282 on the lid 1262, the user may charge the battery packs 1274 when the lid 1262 is in the open position 1264 or the closed position 1266. A plurality of indicator 1275 which indicate status (e.g., charging status, battery health, etc.) of the battery pack 1274 coupled to the charging bay 1282 may be disposed on the lid 1262 adjacent the charging bays 1282.

With continued reference to FIG. 81, the battery packs 1274 may include identification tags 1286 (e.g., RFID tags). The identification tags 1286 allow a user to keep track of various battery packs 1274. In some embodiments, only older battery packs 1274 include an identification tag 1286, thereby allowing a user to differentiate older battery packs 1274 from newer battery packs 1274. A display unit 1290 may additionally be positioned on an outer surface 1294 of the main body 1258. The display unit 1290 indicates the number of battery packs 1274 “checked out” or removed from the charging module 1250.

The display unit 1290 may indicate the “checked out” quantity of battery packs 1274 in response to a user scanning a battery pack 1274 as the battery pack 1274 is removed from the internal chamber 1270. The battery pack 1274 may be scanned by placing the battery pack 1274 in proximity to a scanner 1292, for instance, an RFID scanner, coupled to the main body 1258. The

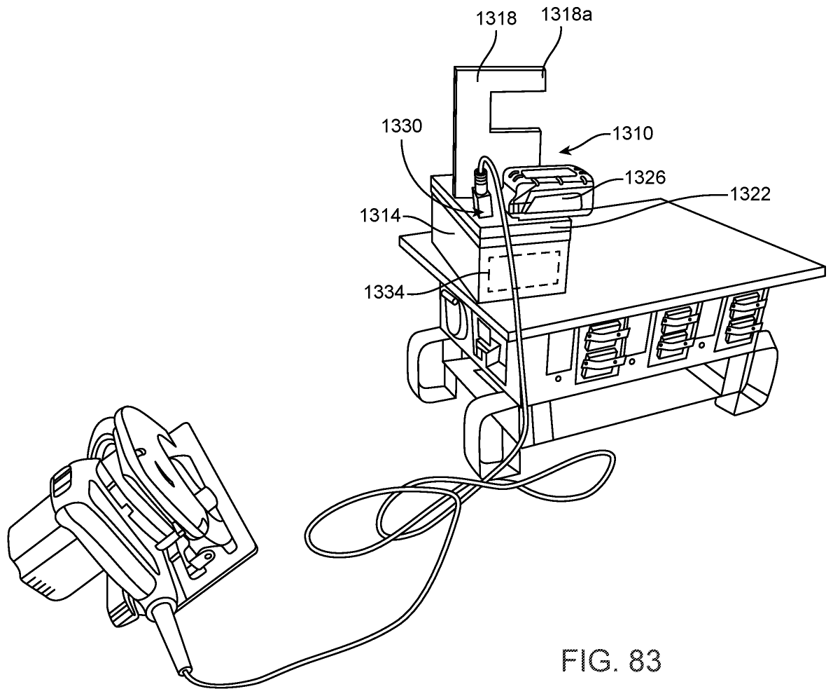

FIG. 83 illustrate another embodiment of a charging module 1310 for a work area. The charging module 1310 includes a base 1314 and a frame 1318 coupled to the base 1314. The base 1314 is generally rectangular and includes charging bays 1322 for receiving a battery pack 1326 (e.g., a power tool battery pack). In the illustrated embodiment, the base 1314 includes two charging bays 1322 configured to receive 12-volt and/or 18-volt power tool battery packs 1326. However, in alternative embodiments, the charging module 1310 may include fewer or additional charging bays 1322. Indicators (not shown) may be positioned adjacent the charging bays 1322 and emit light indicative of the status (e.g., battery health, charging status, temperature, etc.) of the battery pack 1326 coupled to the charging bay 1322.

The base 1314 additionally includes outlets 1330 positioned adjacent the charging bays 1322. The outlets 1330 are soft start outlets configured to manage motor inrush for larger power applications. In the illustrated embodiments, the base 1314 includes two outlets. However, in alternative embodiments, the base 1314 may include fewer or additional outlets and/or alternative types of outlets. The base 1314 may include a battery core 1334 integrated with the base 1314 and configured to provide a power supply (e.g., a DC power supply) to the charging bays 1322 and/or outlets 1330.

With continued reference to FIG. 83, the frame 1318 extends upwardly from the base 1314. More specifically, the frame 1318 is oriented perpendicular relative to the base 1314. The frame 1318 includes at least one extension portion 1318a that extend outward from and generally parallel to the base 1314. The extension portions 1318a act as a hanging hook for the user. More specifically, a user may hang items (e.g., cords, tools, etc.) on the frame 1318. For instance, a user may wrap an electrical cord (not shown) about the extension portion 1318a.

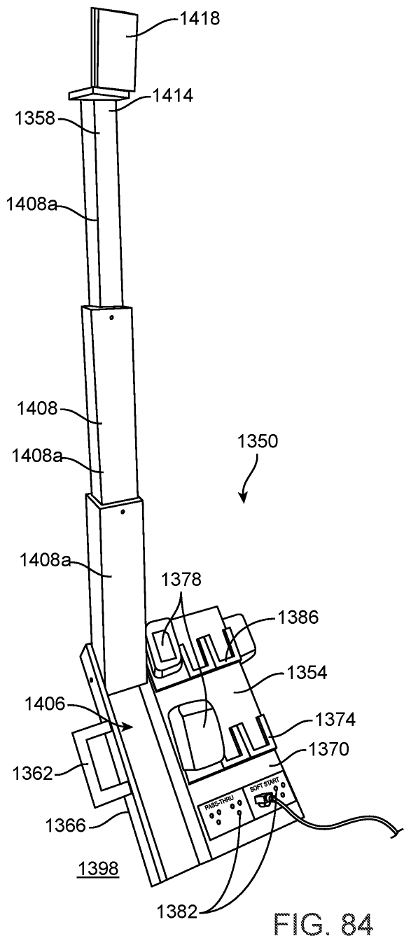

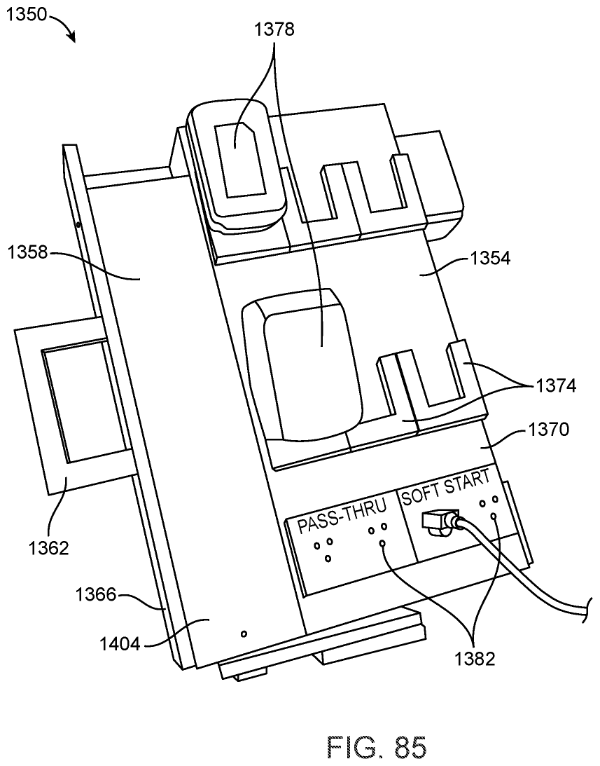

FIGS. 84-87 illustrate another embodiment of a charging module 1350 for a work area. The charging module 1350 includes a base 1354 and a light 1358 pivotally coupled to the base 1354. The base 1354 is generally rectangular and includes a handle 1362 coupled to a side surface 1366 of the base 1354. The handle 1362 defines a grip graspable by the user for transporting and/or supporting the charging module 1350.

An upper surface 1370 of the base 1354 includes charging bays 1374 for receiving a battery pack 1378 (e.g., a power tool battery pack). In the illustrated embodiment, the base 1354 includes four charging bays configured to receive 12-volt power tool battery packs and/or 18-volt power tool battery packs. However, in alternative embodiments, the charging module 1350 may include fewer or additional charging bays and/or charging bays configured to receive power tool battery packs having different capacities. The upper surface 1370 of the base 1354 additionally includes various outlets 1382. Specifically, the upper surface 1370 includes two pass-through GFCI outlets and two soft start outlets. However, alternative types of outlets may be implemented.

With continued reference to FIG. 85, the upper surface 1370 of the base 1354 includes various battery holders 1386. The battery holders 1386 allow a user to store extra battery packs 1378 on the charging module 1350 when not being used and/or charged. In the illustrated embodiment, the charging module 1350 includes three battery holders 1386. However, the charging module 1350 may include fewer or additional charging modules in alternative embodiments. A rear surface 1390 of the base 1354 includes a foldable stand 1394 pivotally coupled to the base 1354. The stand 1394 may pivot away from the base 1354 and contact a work surface 1398, thereby allowing a user to support the charging module 1350 on the work surface 1398. The rear surface 1390 may include mounting features 1402 (e.g., cleats) configured to engage corresponding mounting features of another component of a modular storage system, such as a storage cart 1403.

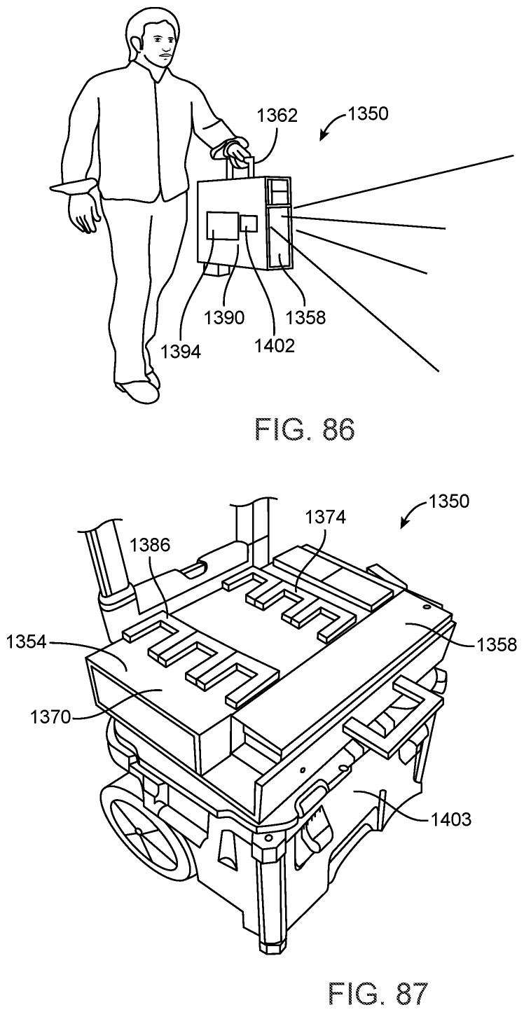

The light 1358 is coupled to the base 1354 and pivotable relative to the base 1354 between a stowed position 1404, where the light 1358 is positioned within a storage compartment 1406 on the base 1354, and a deployed position 1408, where the light 1358 is pivoted away from the base 1354. When the light 1358 is in the deployed position 1408, the light 1358 is configured to telescope to an extended position 1410 away from the base 1354. In that regard, the light includes a plurality of telescope portions 1408a that nest concentrically for compact storage. In the illustrated embodiment, the light 1358 includes three telescope portions 1408a resulting in a length of about six feet when the light 1358 is in the extended position 1410. Fewer or more telescope portions 1408a may be included which results in a length greater than or less than six feet. A distal end 1414 of the light 1358 includes a light head 1418. The light head 1418 is configured to swivel relative to the base 1354 and is configured to provide ambient lighting and/or task lighting. The light 1358 provides improved visibility for a user in poorly lit workspaces. As illustrated in FIG. 86, in the stowed position 1404, the light head 1418 may be swiveled to direct light forward of a user who is carrying the charging module 1350 at a dimly lit worksite. The light head 1418 may include LEDs or other light sources.

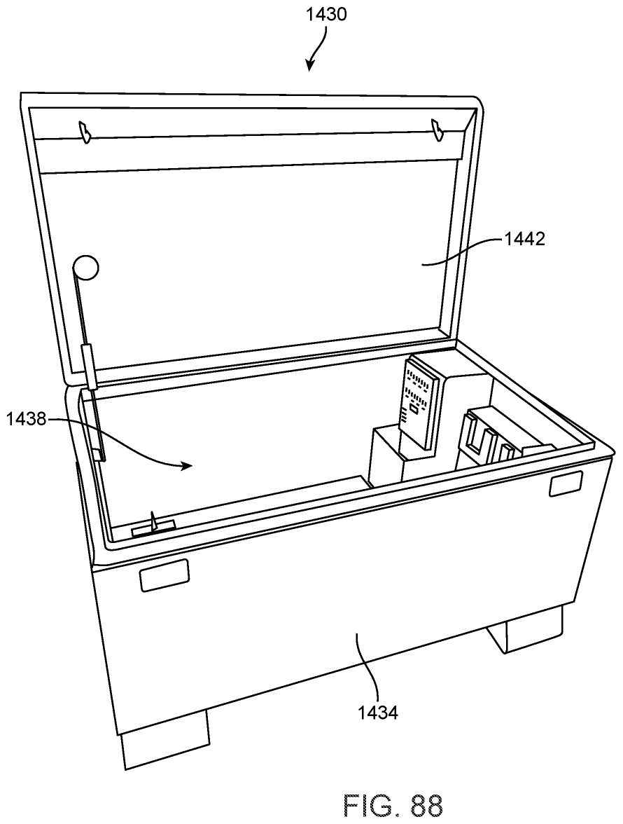

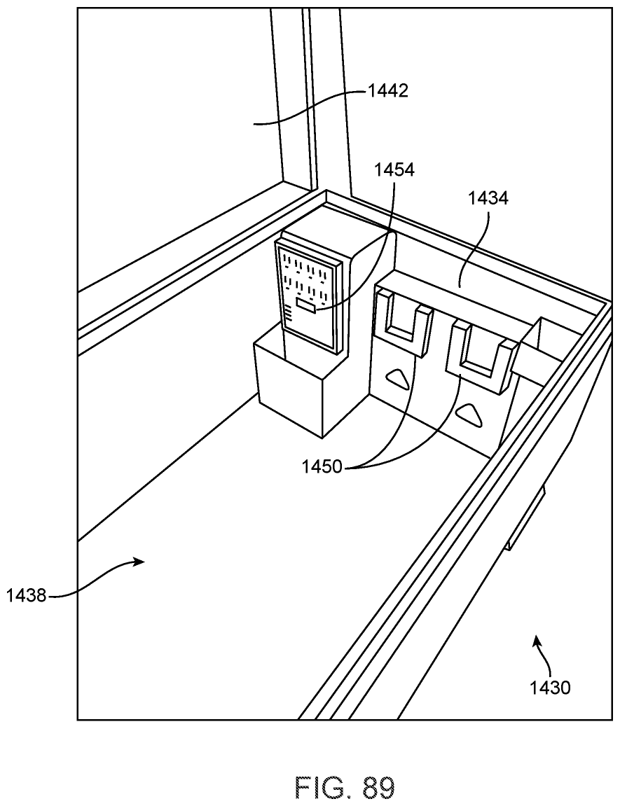

FIGS. 88-89 illustrates another embodiment of a charging module 1430 for a work area. The charging module 1430 is a rectangular box 1434 that defines an internal chamber 1438 and includes a lid 1442 pivotally coupled to the box 1434, enclosing the internal chamber 1438. The box 1434 is composed of a durable material (e.g., steel) and is capable of withstanding damage in the event the box 1434 is dropped. The internal chamber 1438 includes storage space for holding tools (not shown), battery packs 1446, etc. The lid 1442 may be locked relative to the box 1434, thereby securing the items stored within the box 1434.

The internal chamber 1438 within the box 1434 includes charging bays 1450 for receiving a battery pack 1446 (e.g., a power tool battery pack). In the illustrated embodiment, the box 1434 includes two charging bays 1450 configured to receive 12-volt power tool battery packs and/or 18-volt power tool battery packs. However, in alternative embodiments, the charging module 1430 may include fewer or additional charging bays 1450 and/or charging bays 1450 configured to receive alternative types of power tool battery packs 1446. The internal chamber 1438 within the box 1434 additionally includes ports 1454 configured to charge various accessories. Specifically, the ports 1454 includes USB ports, AC pass-through outlets, etc.

Although the disclosure has been described in detail with reference to certain preferred embodiments, variations and modifications exist within the scope and spirit of one or more independent aspects of the disclosure.

1. A charging module configured to receive a battery pack, the charging module comprising:
a housing including a plurality of charging bays spaced about the housing, each charging bay removably receiving the battery pack; and
a light coupled to the housing, the light illuminating a space surrounding the charging module.

2. The charging module of claim 1, further comprising a plurality of indicators positioned adjacent the plurality of charging bays, the indicators configured to indicate a status of the battery pack.

3. The charging module of claim 1, further comprising a plurality of ports positioned about the housing.

4. The charging module of claim 3, wherein the ports include an AC pass-through port.

5. The charging module of claim 1, wherein the light extends upward from the housing.

6. The charging module of claim 5, wherein the light is generally rectangular.

7. The charging module of claim 1, wherein the light illuminates about a 360-degree range about the charging module.

8. The charging module of claim 5, wherein the light includes a lens at a top surface of the light illuminating above the charging module.

9. The charging module of claim 5, wherein the light includes a handle extending circumferentially about the light.

10. The charging module of claim 1, further comprising a plurality of cord wraps coupled to the housing.

11. The charging module of claim 1, further comprising a base extending downward from the housing, the light coupled to the housing between the base and the housing.

12. The charging module of claim 11, wherein the base defines a cord wrap portion.

13. The charging module of claim 1, further comprising at least one lid coupled to the housing, the housing defining an internal compartment in which the charging bays are positioned.

14. A charging module configured to receive and recharge a plurality of battery packs, the charging module comprising:
a base defining an internal chamber in which a plurality of charging bays are positioned, each charging bay removably receiving a battery pack; and
at least one door pivotally coupled to the base, the door pivotable between an open position and a closed position and enclosing the internal chamber.

15. The charging module of claim 14, further comprising a padlock, the padlock engaging the door to maintain the door in the closed position.

16. The charging module of claim 14, further comprising at least one charging port, the charging port electrically couplable to a mobile device.

17. The charging module of claim 14, further comprising a mounting plate coupled to a back surface of the base, the mounting plate including mounting interfaces configured to interact with an existing structure.

18. The charging module of claim 14, further comprising a heater supported in the base.

19. The charging module of claim 14, wherein the internal chamber further defines a storage compartment adjacent the charging bays.

20. A charging system configured to removably receive and recharge a plurality of battery packs, the charging system comprising:
a dolly including a pair of rails and a platform rotatably coupled therebetween; and
a plurality of charging modules coupled to the pair of rails, the charging modules having a housing defining an interior compartment having a plurality of charging bays, each charging bay removably receiving the battery pack, the charging modules electrically coupled together.

21. The charging system of claim 20, wherein the housing supports a heating element and a switch, the heating element activated by the switch.

22. The charging system of claim 21, wherein the switch includes a temperature sensor.

23. The charging system of claim 20, wherein the charging module includes a pair of doors pivotally coupled to the housing, the doors enclosing the interior compartment.

24. The charging system of claim 23, wherein the charging module further comprises a door lock and an RFID reader, the door lock engaging the doors to maintain the doors in a closed position, the RFID reader configured to disengage the door lock.

25. The charging system of claim 20, wherein the charging module includes a pass-through outlet positioned on a side of the housing.

26. The charging system of claim 20, wherein the charging module includes a power inlet positioned on a side of the housing.

27. The charging system of claim 20, wherein the charging module includes a slot disposed on a back surface of the module, the slot communicating the interior compartment and an exterior of the module, a locking feature extending through the slot and engageable by a lock disposed in the interior compartment for locking the charging module to the dolly.

28. The charging system of claim 20, wherein the charging module includes a back surface, the back surface having a plurality of mounting features disposed about the back surface.

29.-43. (canceled)
